(19) United States
(12) Patent Application Publication
(10) Pub. No.: US 2006/0024625 A1
(43) Pub. Date: Feb. 2, 2006

(54) Silver halide emulsion and silver halide photographic material

(75) Inventors: Toshiya Kondo, Tokyo (JP); Katsuya Yabuuchi, Tokyo (JP); Rieko Ren, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA PHOTO IMAGING, INC.

(21) Appl. No.: 11/048,697

(22) Filed: Feb. 3, 2005

(30) Foreign Application Priority Data
Feb. 6, 2004 (JP) JP2004-030381

(51) Int. Cl. G03C 1/005

(52) U.S. Cl. 430/567

(57) ABSTRACT

A silver halide emulsion is disclosed, comprising silver halide grains, wherein at least 50% by number of the silver halide grains is accounted for by grains having an aspect ratio of less than 1.3, and the silver halide grains have an average chloride content of not less than 90 mol %, an average iodide content of from 0.02 to 2 mol % and an average bromide content of from 0.1 to 9 mol %, wherein the silver halide grains exhibit a coefficient of variation in iodide content among grains of less than 40%.

### FIELD OF THE INVENTION

The present invention relates to a silver halide photographic emulsion, a silver halide photographic material and an image forming method specifically when subjected to digital exposure at a relatively high intensity for a short time.

### BACKGROUND OF THE INVENTION

The recent rapid directivity to digitization has led to increased opportunities of subjecting silver halide photographic materials to digital exposure. Along with such a trend, photographic color paper as a photographic material for color prints is desired with respect to suitability for exposure at a relatively high intensity for an extremely short time at the level of milli-seconds to nano-seconds and aptitude for scanning exposure.

There have been employed silver chloride emulsions or high chloride silver halide emulsions in color paper to achieve rapid processability. Further, it is commonly known that doping iridium compounds is effective to improve reciprocity law failure characteristics as a matter of properties of silver halide emulsions. There are disclosed high chloride silver halide emulsion grains having a high bromide region in the vicinity of the corners of the grains, as described in JP-A No. 64-26837 (hereinafter, the term JP-A refers to Japanese Patent Application Publication); high chloride silver halide emulsion grains in which a bromide-localized region is selectively doped with an iridium compound, thereby leading to superior latent image stability and reciprocity law failure characteristics, as described in JP-A No. 1-105940. There is also disclosed a method of forming a bromide-localized region by using silver bromide fine-grains doped with an iridium compound, as described in U.S. Pat. No. 5,627,020. However, neither of the foregoing methods was sufficient for improving latent image stability in the initial stage after exposure.

In digital exposure systems of the recent subject, it was proved that sufficient practical qualities were not achieved by only known techniques for improving latent image stability, in exposure suitability at a high intensity for an extremely short time. Techniques adaptable to such a digital exposure system include, for examples, chemical sensitization and spectral sensitization suitable for formation of a bromide-localized phase, as described in U.S. Pat. No. 5,691,119; and the use of a silver iodochloride emulsion, as described in European Patent Nos. 750,222 and 772,079.

However, it was proved in studies by the inventors of this application that the foregoing techniques for improving aptitude for digital exposure was not only insufficient for improving latent image stability but also resulted in marked deteriorated pressure resistance and pre-exposure storage stability of photographic materials. It is desired to immediately solve this matter.

JP-A No. 2001-188311 discloses a method for improving reciprocity law failure and coating solution stability, in which silver halide grains contain a bromide-rich or iodide-rich phase in the vicinity of the grain surface and introduction of such a rich phase is separated into two occasions, before and after addition of mercapto compounds. However, it was proved that using only this method was insufficient for improving storage stability of silver halide emulsions.

There were disclosed techniques for improving photographic performance such as sensitivity, fogging and reciprocity law failure by using silver iodochloride grains exhibiting iodide content decreasing from the grain surface in the direction of depth, as disclosed in JP-A No. 2002-174870, and high chloride silver halide grains having a maximum iodide content in the corners greater than that of the major faces, as disclosed in JP-A No. 2002-296718. However, there is further desired a technical improvement to achieve enhanced photographic performance and storage stability.

With regard to selenium sensitization, JP-A No. 5-66513 and U.S. Pat. No. 5,240,827 disclosed photographic elements comprising silver chloride grains containing a selenium compound on the grain surface, in which photographic performance, except for sensitivity was unclear and there was no description regarding gamma, a latent image and other performances required in photographic materials for print, so that it was difficult to provide a practical silver halide photographic material satisfying recently required performances. JP-A Nos. 5-313293, 9-5922 and 9-5924 disclosed silver halide photographic materials applying selenium or tellurium sensitization to silver chloride or high chloride silver bromochloride grains, in which improvement for performance such as latent image stability and coating solution stability were unknown and of which effects on sensitivity and gamma were insufficient to meet the recent demand for silver halide photographic material.

There were disclosed techniques for applying 8th group metal complexes containing an aqua ligand to silver halide grains, including a silver halide grain emulsion containing an iridium complex having halogen and aqua ligands and also having an iridium complex containing layer localized on the grain surface, as disclosed, for example, in JP-A No. 11-202440, and a silver halide emulsion containing high chloride silver halide grains occluding an iridium complex having an aqua ligand, as disclosed in JP-A No. 2001-356441. There were also disclosed techniques for applying 8th group metal complexes containing an organic ligand to silver halide grains, including a silver halide emulsion containing high chloride silver halide grains occluding a six-coordinate complex of metals other than iridium and an iridium complex containing a thiazole or substituted thiazole ligand, as disclosed in U.S. Pat. No. 6,107,018, and a silver halide emulsion containing high chloride silver halide grains occluding an iridium complex containing an aqua or thiazole ligand and an iridium complex containing a halogen ligand, as disclosed in JP-A No. 2002-162708. However, the foregoing techniques were insufficient to meet recent requirements for enhanced sensitivity, latent image stability and digital exposure suitability.

### SUMMARY OF THE INVENTION

Accordingly, it is an object of the present invention to provide a silver halide emulsion and a silver halide photographic material exhibiting enhanced sensitivity, reduced fogging, and superior latent image stability and storage stability, whereby high quality prints can stably be obtained and superior image quality and print reproducibility are achieved even in digital exposure at high intensity for a short period and an image forming method by use thereof.

In one aspect the present invention is directed to a silver halide emulsion comprising silver halide grains, wherein the silver halide grains have an average aspect ratio of from 1.0 to 1.3 and at least 50% by number of the silver halide grains is accounted for by grains having a chloride content of not less than 90 mol %, an iodide content of from 0.02 to 2 mol %, a bromide content of from 0.1 to 9 mol % and a coefficient of variation in iodide content among grains of less than 40%.

In one aspect the invention is directed to a silver halide emulsion comprising silver halide grains, wherein the silver halide grains have an average aspect ratio of from 1.0 to 1.3 and at least 50% by number of the silver halide grains is accounted for by grains having a chloride content of not less than 90 mol %, an iodide content of from 0 to 2 mol % and a bromide content of from 0.1 to 10 mol %, wherein the silver halide grains have an average surface bromide content of from 0.3 to 10 mol %.

In one aspect the invention is directed to a silver halide emulsion comprising silver halide grains, wherein the silver halide grains have an average aspect ratio of from 1.0 to 1.3 and at least 50% by number of the silver halide grains is accounted for by grains having a chloride content of not less than 90 mol %, an iodide content of from 0.02 to 2 mol % and a bromide content of from 0.1 to 9 mol % and the silver halide grains further having each an iodide content of an corner region of the grain of from 0.6 A to 1.4 A mol %, in which A is an average iodide content of corner regions of the grains.

### DESCRIPTION OF PREFERRED EMBODIMENTS

One feature of silver halide emulsions relating to this invention is that silver halide grains having an aspect ratio of less than 1.3 account for at least 50% by number of the total silver halide grains, preferably at least 70%, and more preferably at least 80%, in which the lower limit of the aspect ratio is 1.0.

The aspect ratio of silver halide grains is defined in the following equation and can be determined by measuring the grain diameter and thickness for the respective grains:
Aspect ratio=grain diameter/grain thickness.

To determine the grain diameter or aspect ratio of silver halide grains, the projected area or thickness for each grain can be determined in accordance with the following procedure. A sample is prepared by coating a silver halide emulsion containing latex balls having a known diameter as an internal standard on a support so that the major faces are arranged in parallel to the support surface. After being subjected to shadowing by carbon vapor evaporation, replica sample is prepared in any of the conventional replica methods. From electron micrographs of the sample, the diameter of a circle equivalent to the grain projected area and grain thickness are determined using an image processing apparatus. In this case, the projected grain area can be determined from the internal standard and the projection area and the grain thickness can be determined from the internal standard and silver halide grain shadow. The average aspect ratio is an arithmetic average of aspect ratios of at least 300 silver halide grains.

Silver halide grains usable in this invention may be in any form and cubic grains having (100) crystal surfaces are preferred. There are also usable octahedral grains, tetradecahedral grains, tetracosahedral grains and dodecahedral grains, prepared in accordance with methods described in U.S. Pat. Nos. 4,183,756 and 4,225,666; JP-A No. 55-26589; JP-B No. 55-42737 (hereinafter, the term, JP-B refers to Japanese Patent Publication); The Journal of Photographic Science (J. Photogr. Sci.) vol. 21, page 39 (1973). There may be used grains having twin plane. Silver halide grains having a single form are preferred in this invention and at least two monodisperse silver halide emulsions may be incorporated in a single layer.

The grain size of silver halide grains is not specifically limited but is preferably from 0.1 to 5.0 μm, more preferably from 0.1 to 1.2 μm, and still more preferably 0.15 to 1.0 μm in terms of rapid processability, sensitivity and other photographic performance.

Monodisperse silver halide grains exhibiting a coefficient of variation in grain size distribution of not more than 0.22 (more preferably not more than 0.15, and still more preferably not more than 0.1) are preferred. The coefficient of variation (hereinafter, also denoted as variation coefficient) is a factor representing the width of grain size distribution and defined as below:
variation coefficient=S/R
wherein S is the standard deviation of grain size distribution and R is the average grain diameter. The grain diameter is a diameter when the grain is spherical, and is the diameter of a circle having the same area as the projected area of a grain when the grain is cubic or in a form other than sphere.

In one aspect, the silver halide of the invention comprises silver halide grains, wherein the silver halide grains have an average aspect ratio of 1.0 to 1.3 and at least 50% by number (preferably at least 70% and more preferably at least 80% by number) of the silver halide grains is accounted for by grains having a chloride content of not less than 90 mol % (preferably not less than 93 mol % and more preferably not less than 95 mol %), an iodide content of from 0.02 to 2 mol % (preferably from 0.05 to 2.0 mol %, more preferably from 0.05 to 1.0 mol % and still more preferably from 0.1 to 1.0 mol %), a bromide content of from 0.1 to 9.0 mol % (preferably from 0.1 to 8.0 mol %, more preferably from 1.5 to 6.0 mol % and still more preferably from 2.5 to 6.0 mol %), and a coefficient of variation of iodide contents among grains of less than 40% (preferably less than 30% and more preferably less than 20%).

In one aspect, the silver halide emulsion of the invention comprises silver halide grains, wherein the silver halide grains have an average aspect ratio of 1.0 to 1.3 and at least 50% by number (preferably at least 70% and more preferably at least 80% by number) of the silver halide grains is accounted for by grains having a chloride content of not less than 90 mol % (preferably not less than 93 mol % and more preferably not less than 95 mol %), an iodide content of from 0 to 2.0 mol % (preferably from 0.02 to 2.0 mol %, more preferably from 0.05 to 1.0 mol % and still more preferably from 0.1 to 1.0 mol %) and a bromide content of from 0.1 to 10.0 mol % (preferably from 1.0 to 8.0 mol % and more preferably from 1.5 to 6.0 mol %), and the silver halide grains have an average surface bromide content of from 0.3 to 10.0 mol % (preferably from 1.0 to 10.0 mol %, more preferably from 2.5 to 10.0 mol % and still more preferably from 4.0 to 10.0 mol %).

In one aspect, a silver halide emulsion of the invention comprises silver halide grains, wherein the silver halide grains have an average aspect ratio of 1.0 to 1.3 and at least 50% by number (preferably at least 70% and more preferably at least 80% by number) of the silver halide grains is accounted for by grains having a chloride content of not less than 90 mol % (preferably not less than 93 mol % and more preferably not less than 95 mol %), an iodide content of from 0.02 to 2.0 mol % (preferably from 0.05 to 2.0 mol %, more preferably from 0.05 to 1.0 mol % and still more preferably from 0.1 to 1.0 mol %) and a bromide content of from 0.1 to 9.0 mol % (preferably from 0.1 to 8.0 mol %, more preferably from 1.5 to 6.0 mol % and still more preferably from 2.5 to 6.0 mol %), and wherein the silver halide grains each have an iodide content of an corner region of the grain of from 0.6 A to 1.4 A mol %, in which A is an average iodide content of corner regions of the grains.

The silver halide grains relating to this invention preferably have at least one iodide-localized silver halide phase in the interior of the grains. In the invention, the interior of the grains refers to a silver halide phase, except for the grain surface. The iodide-localized silver halide phase (hereinafter, also denoted as iodide-localized phase) is a silver halide phase having at least two times the average iodide content of the grains, preferably at least three times the average iodide content, and more preferably at least 5 times the average iodide content. The iodide-localized phase is located in a portion external to 60% (preferably 70%, and more preferably 80%) of the grain volume within the grain. In other words, the iodide-localized phase is located in an exterior region outside the interior region accounting for at least 60% of the total silver forming the grains. The iodide-localized phase is located in a portion external to preferably 70%, and more preferably 80% of the grain volume within the grain. In one preferred embodiment, the iodide-localized phase exists in the form of a layer in the interior of the grain (which is hereinafter also called iodide-localized layer) and the iodide-localized layer preferably composed of at least two layers, in which the main layer is introduced according to the conditions described above and at least one layer (hereinafter, called a sub-layer) having an iodide content less than the maximum iodide content is introduced closer to the grain surface than the main layer. Iodide contents of the main layer and sub-layer can be chosen in accordance with the objective. Preferably, the main layer has an iodide content as high as possible and the sub-layer has an iodide content lower than the main layer from the viewpoint of latent image stability. In another preferred embodiment, the iodide-localized phase, which exists in the vicinity of corners or edges of the grain can be used in combination with the foregoing iodide-localized phase.

A silver halide emulsion comprising silver halide grains having a high bromide portion within the grain is also preferred in this invention. The high bromide portion may be formed by an epitaxial junction or by forming a core/shell structure. Alternatively, there may exist regions partially differing in bromide composition without forming a complete layer. The bromide composition may be continuously varied or discontinuously varied, and silver halide grains having a bromide-localized phase in the vicinity of corners of the grain are preferred. The expression bromide-localized phase herein means a silver halide phase having a relatively high bromide content. Thus, the bromide-localized phase has a bromide content of at least two times the average bromide content of the grains, preferably at least three times and more preferably at least 5 times the average bromide content. The bromide-localized phase preferably contains a Group 8 metal compound, as described later. The Group 8 metal compound is preferably an iridium complex compound.

In the silver halide grain emulsion of this invention, the coefficient of variation of iodide contents among grains is less than 40%, preferably less than 30%, and more preferably less than 20%. The lower limit of a coefficient of variation of iodide contents among grains preferably is 0.01%. A coefficient of variation of bromide contents among grains is preferably less than 30%, and more preferably less than 20%. The minimum of a coefficient of variation of bromide contents among grains is preferably 0.01%.

The chloride content, bromide content and iodide content of silver halide grains can be determined in the EPMA method (Electron Probe Micro Analyzer method). Thus, silver halide grains are dispersed so as to not be in contact with each other to prepare a sample. The sample is irradiated with an electron beam, while cooling at a temperature of not more than 100° C. using liquid nitrogen, and the characteristic X-ray intensities of silver, chlorine, bromine and iodine, radiated from a single silver halide grain are measured to determine chloride, bromide and iodide contents of the grain. According to the foregoing manner, bromide contents determined for the individual grains are measured for at least 300 grains and an averaged value thereof is defined as the average bromide content of the grains. A coefficient of variation of bromide contents among grains can be calculated according to the following equation:
coefficient of variation of bromide contents among grains=[(standard deviation of bromide content of silver halide grains)/(average bromide content)]×100 (%).

According to the foregoing manner, the iodide contents determined for the individual grains are measured for at least 300 grains and the averaged value thereof is defined as the average iodide content of the grains. A coefficient of variation of iodide contents among grains can be calculated according to the following equation:
coefficient of variation of iodide contents among grains=[(standard deviation of iodide content of silver halide grains)/(average iodide content)]×100 (%).

Silver halide grains included in the silver halide emulsion of this invention preferably have an average surface bromide content of from 0.3 to 10 mol %, more preferably from 0.5 to 10 mol %, and still more preferably from 1 to 8 mol %.

The surface iodide content refers to the average bromide content of a silver halide phase from the grain surface to a depth of 50 A inclusive and is determined by the XPS method (X-ray Photoelectron Spectroscopy). Specifically, the XPS method used in this invention is carried out according to the following procedure. Thus, a 0.05 wt. % aqueous proteinase solution is added to a silver halide emulsion sample and stirred at 45° C. for 30 min. to degrade the gelatin. The emulsion is subjected to centrifugal separation to allow emulsion grains to sediment, followed by removing the supernatant liquid. Then, distilled water is added thereto to disperse the emulsion grains in water and thinly coated on a mirror-polished silicon wafer to prepare a test sample. Surface iodide measurement by the XPS method was conducted using the thus prepared sample. To prevent destruction of the sample caused by X-ray exposure, the sample is cooled to a temperature of −110 to −120° C. in a closed chamber for XPS measurement. The sample was exposed to an X-ray for probe of MgKa at an X-ray source voltage of 15 kV and an X-ray source current of 40 mA, and measured with respect to Ag3d5/2, Br3d, and I3d3/2 electrons. The integral peak intensity is corrected for by a sensitivity factor and halide composition on the outer surface layer is determined from the thus obtained intensity ratio.

In one embodiment of the invention, when the average iodide content of corner regions of silver halide grains is in A mol %, grains having an iodide content of the corner regions of from 0.6 A to 1.4 A mol % account for at least 50% by number of the whole grains, preferably at least 70% and more preferably at least 80% by number. It is further preferred that grains having an iodide of the corners of from 0.7 A to 1.3 A mol % account for at least 50% by number of the whole grains and more preferably at least 70%.

The corner of a silver halide grain refers to a corner of the outer surface of the silver halide grain and when a circle having a radius of 1/10 of the equivalent circle diameter of the silver halide grain is drawn centering on the corner (i.e., when the circle is drawn around the corner as the center), the corner region is the region within the circle. In the case of a silver halide grain being rounded, the intersection of lines tangent to the periphery of the grain is defined as the corner of the grain and the region extrapolated from this corner is defined as the corner region.

The average iodide content, A mol % of the corner region of silver halide grains is an average value of the iodide contents of whole corner regions including corner regions within a grain and among grains. Silver halide grains are taken out through degradation of gelatin by using proteinase and placed on a substrate to prepare a sample. This sample is inclined so that the corner region is exposed to a beam in the commonly known EPMA method, whereby the iodide content is determined for at least random 200 grains (preferably at least 400 random grains) by point analysis with narrowing down to a spot diameter of 50 A or less (preferably 20 A or less) and the averaged value thereof is defined as iodide content A (mol %).

There can be used various iodine compounds to allow silver iodide to be contained in silver halide grains. Examples thereof include the use of an aqueous iodide salt solution, such as an aqueous potassium iodide solution, the use of a polyiodide compound, as described in S. Nakahara “Mukikagobutsu-Sakutai Jiten” (Dictionary of Inorganic Compound and Complex, page 944, published by Kodan-sha) and the use of fine iodide-containing silver halide grains or iodide ion-releasing agents, as disclosed in JP-A No. 2-68538. The use of an aqueous iodide salt solution, fine iodide-containing silver halide grains or iodide ion-releasing agents is preferred, the use of iodide ion-releasing agents is more preferred, and the use of iodide ion-releasing compounds described in JP-A No. 11-271912 is specifically preferred. The iodide content of silver halide grains and the iodide content of an iodide-localized phase can arbitrarily be controlled by adjusting the concentration or the quantity of an iodide containing solution.

There can also be used various bromide compounds to allow silver bromide to be contained in silver halide grains. Examples thereof include the use of an aqueous bromide salt solution, such as an aqueous potassium bromide solution, the use of bromide-containing silver halide fine-grains or bromide ion-releasing agents, as disclosed in JP-A No. 2-68538. Of these, use of an aqueous bromide salt solution, fine bromide-containing silver halide grains or bromide ion-releasing agents is preferred, the use of bromide ion-releasing agents is more preferred, and the use of bromide ion-releasing compounds described in JP-A No. 11-271912 is specifically preferred. The bromide content of silver halide grains and the bromide content of a bromide-localized phase can arbitrarily be controlled by adjusting the concentration or the quantity of an bromide containing solution.

When allowing silver iodide and/or silver bromide to be contained in a silver halide phase by supplying silver halide fine-grains, the silver halide fine-grains preferably have an average grain size of not more than 0.05 μm, more preferably from 0.001 to 0.03 μm, and still more preferably from 0.001 to 0.02 μm. The silver halide fine-grains are prepared preferably using a low molecular weight gelatin having an average molecular weight of 40,000 or less, more preferably from 5,000 to 25,000, and still more preferably from 5,000 to 15,000. The silver halide fine-grains are prepared preferably at a temperature of not more than 40° C., more preferably not more than 30° C., and still more preferably from 5 to 20° C. The silver halide fine-grains can be prepared by commonly known methods and apparatuses and the use of a continuous nucleation apparatus described in JP-A No. 2000-112049 is specifically preferred.

Silver halide grains preferably include at least one metal complex containing an aqua or organic ligand (or both of them) in combination with a metal of group 8 of the periodical table of elements (which is hereinafter also denoted as a group 8 metal complex containing an aqua or organic ligand). The group 8 metal complex usable in this invention preferably is a metal complex of iridium, rhodium, osmium, ruthenium, cobalt or platinum. The metal complex may be a six-coordinate complex, five-coordinate complex, four-coordinate complex or two-coordinate complex, and a six-coordinate complex and a four-coordinate complex are preferred of the foregoing group 8 metal complexes containing an aqua ligand and/or an organic ligand or both of them, an iridium metal complex is preferred.

Any ligand is usable and examples of a ligand include carbonyl ligand, fulminate ligand, thiocyanate ligand, nitrosyl ligand, thionitrosyl ligand, cyano ligand, water ligand [in which water as a ligand is called an aqua (or aquo-) ligand], halogen ligand, ligands of ammonia, a hydroxide, nitrous acid, sulfurous acid and a peroxide and organic ligands of these, it is preferred to contain at least one ligand selected from nitrocyl ligand, thionitrocyl ligand, cyano ligand, aqua ligand, halogen ligand and an organic ligand. In this invention, the organic ligand refers to a compound containing at least one of H—C, C—C and C—N—H bonds and capable of being coordinated with a metal ion. Preferred organic ligands usable in this invention include a compound selected from pyridine, pyrazine, pyrimidine, pyrane, pyridazine, imidazole, thiazole, isothiazole, triazole, pyrazole, furan, furazane, oxazole, isooxazole, thiophene, phenthroline, bipyridine and ethylenediamine, their ions and compounds substituted with the foregoing compounds.

Preferred examples of a group 8 metal complex containing at least an aqua ligand and/or an organic ligand are shown below but are by no means limited to these. Any counter cation is usable, including potassium ion, calcium ion, sodium ion ammonium ion. Counter anions for the metal complex include nitrate ion, halide ion and perchlorate ion.

(A-1) K[IrBr₅(H₂O)]

(A-2) K₂[IrBr₅(H₂O)]

(A-3) K₃[IrBr₅(H₂O)]

(A-4) K₄[IrBr₅(H₂O)]

(A-5) K[IrBr₄(H₂O)₂]

(A-6) [IrBr₄(H₂O)₂]

(A-7) [IrBr₃(H₂O)₃]

(A-8) [IrBr₃(H₂O)₃]Br

(A-9) K[IrCl5(H₂O)]

(A-10) K₂[IrCl₅(H₂O)]

(A-11) K₃[IrCl₅(H₂O)]

(A-12) K₄[IrCl₅(H₂O)]

(A-13) K[IrCl₄(H₂O)₂]

(A-14) [IrCl₄(H₂O)₂]

(A-15) [IrCl₃(H₂O)₃]

(A-16) [IrBr₃(H₂O)₃]Cl

(B-1) K₂[RhCl₅(H₂O)]

(B-2) K₂[OsCl₅(H₂O)]

(B-3) K₂[RuCl₅(H₂O)]

(B-4) K[Rh(NO)(H₂O)Cl₄]

(B-5) K[Rh(NO)(H₂O)Br₄]

(C-1) [Ir(bipy)Cl₄]

(C-2) [Ir(bipy)Br₄]

(C-3) [Ir(bipy)₃]²⁺

(C-4) [Ir(py)₆]²⁺

(C-5) [Ir(phen)₃]²⁺

(C-6) [IrCl₂(bipy)₂]⁰

(C-7) [Ir(thia)₆]²⁺

(C-8) [IrCl₅(thia)]²⁻

(C-9) [IrCl₄(thia)₂]⁻

(C-10) [IrCl₅(5-methylthia)]²⁻

(C-11) [IrCl₄(5-methylthia)₂]⁻

(C-12) [IrBr₅(thia)]²⁻

(C-13) [IrBr₄(thia)₂]⁻

(C-14) [IrBr₅(5-methylthia)]²⁻

(C-15) [IrBr₄(5-methylthia)₂]⁻

(C-16) [Ir(phen)(bipy)₃]²⁺

(C-17) [Ir(im)₆]²⁺

(C-18) [IrCl₅(im)]²⁻

(C-19) [IrCl₄(im)₂]⁻

(C-20) [IrBr₅(im)]²⁻

(C-21) [IrBr₄(im)₂]¹⁻

(C-22) [Ir(NCS)₂(bipy)₂]⁰

(C-23) [Ir(CN)₂(bipy)₂]⁰

(C-24) [IrCl₂(bipy)₃]⁰

(C-25) [IrCl₂(bipy)₂]⁰

(C-26) [Ir(phen)(bipy)₂]²⁺

(C-27) [Ir(NCS)₂(bipy)₂]⁰

(C-28) [Ir(NCS)₂(bipy)₂]⁰

(C-29) [Ir(bipy)₂(H₂O)(bipy′)₂]⁰

(C-30) [Ir(bipy)₂(OH)(bipy′)]⁺

(C-31) [Ir(bipy)Cl₄]²⁻

(C-32) [Ir(bipy)₃]³⁺

(C-33) [Ir(py)₆]³⁺

(C-34) [Ir(phen)₃]³⁺

(C-35) [IrCl₂(bipy)₂]⁺

(C-36) [Ir(thia)₆]³⁺

(C-37) [Ir(phen)(bipy)₃]³⁺

(C-38) [Ir(im)₆]³⁺

(C-39) [Ir(NCS)₂(bipy)₂]⁺

(C-40) [Ir(CN)₂(bipy)₂]⁺

(C-41) [IrCl₂(bipy)₃]⁺

(C-42) [IrCl₂(bipy)₂]⁺

(C-43) [Ir(phen)(bipy)₂]³⁺

(C-44) [Ir(NCS)₂(bipy)₂]⁺

(C-45) [Ir(NCS)₂(bipy)₂]⁺

(C-46) [Ir(bipy)₂(H₂O)(bipy)]³⁺

(C-47) [Ir(bipy)₂(OH)(bipy′)]²⁺

(D-1) [Ru(bipy)Cl₄]⁻

(D-2) [Ru(bipy)₃]²⁺

(D-3) [Ru(py)₆]²⁺

(D-4) [Ru(phen)₃]²⁺

(D-5) [RuCl₂(bipy)₂]⁰

(D-6) [Ru(thia)₆]²⁺

(D-7) [Ru(phen)(bipy)₃]²⁺

(D-8) [Ru(im)₆]²⁺

(D-9) [Ru(NCS)₂(bipy)₂]⁰

(D-10) [Ru(CN)₂(bipy)₂]⁰

(D-11) [RuCl₂(bipy)₃]⁰

(D-12) [RuCl₂(bipy)₂]⁰

(D-13) [Ru(phen)(bipy)₂]²⁺

(D-14) [Ru(NCS)₂(bipy)₂]⁰

(D-15) [Ru(NCS)₂(bipy)₂]⁰

(D-16) [Fe(bipy)Cl₄]⁻

(D-17) [Fe(bipy)₃]²⁺

(D-18) [Fe(py)₆]²⁺

(D-19) [Fe(phen)₃]²⁺

(D-20) [FeCl₂(bipy)₂]⁰

(D-21) [Fe(thia)₆]²⁺

(D-22) [Fe(phen)(bipy)₃]²⁺

(D-23) [Fe(im)₆]²⁺

(D-24) [Fe(NCS)₂(bipy)₂]⁰

(D-25) [Fe(CN)₂(bipy)₂]⁰

(D-26) [FeCl₂(bipy)₃]⁰

(D-27) [Fe(NCS)₂(bipy)₂]⁰

(D-28) [Fe(phen)(bipy)₂]²⁺

(D-29) [Fe(NCS)₂(bipy)₂]⁰

(D-30) [Fe(NCS)₂(bipy)₂]⁰

(D-31) [Os(bipy)Cl₄]⁻

(D-32) [Os(bipy)₃]²⁺

(D-33) [Os(py)₆]²⁺

(D-34) [Os(phen)₃]²⁺

(D-35) [OsCl₂(bipy)₂]⁰

(D-36) [Os(thia)₆]²⁺

(D-37) [Os(phen)(bipy)₃]²⁺

(D-38) [Os(im)₆]²⁺

(D-39) [Os(NCS)₂(bipy)₂]⁰

(D-40) [Os(CN)₂(bipy)₂]⁰

(D-41) [OsCl₂(bipy)₃]⁰

(D-42) [OsCl₂(bipy)₂]⁰

(D-43) [Os(phen)(bipy)₂]²⁺

(D-44) [Os(NCS)₂(bipy)₂]⁰

(D-45) [Os(NCS)₂(bipy)₂]⁰

(D-46) [Co(bipy)Cl₄]⁻

(D-47) [Co(bipy)₃]²⁺

(D-48) [Co(py)₆]²⁺

(D-49) [Co(phen)₃]²⁺

(D-50) [COCl₂(bipy)₂]⁰

(D-51) [Co(thia)₆]²⁺

(D-52) [Co(phen)(bipy)₃]²⁺

(D-53) [Co(im)₆]²⁺

(D-54) [Co(NCS)₂(BIPY)₂]⁰

(D-55) [Co(CN)₂(bipy)₂]⁰

(D-56) [COCl₂(bipy)₃]⁰

(D-57) [CoCl₂(bipy)₂]⁰

(D-58) [Co(phen)(bipy)₂]²⁺

(D-59) [Co(NCS)₂(bipy)₂]⁰

(D-60) [Co(NCS)₂(bipy)₂]⁰

(D-61) [Rh(bipy)Cl₄]⁻

(D-62) [Rh(bipy)₃]²⁺

(D-63) [Rh(py)₆]²⁺

(D-64) [Rh(phen)₃]²⁺

(D-65) [RhCl₂(bipy)₂]⁰

(D-66) [Rh(thia)₆]²⁺

(D-67) [Rh(phen)(bipy)₃]²⁺

(D-68) [Rh(im)₆]²⁺

(D-69) [Rh(NCS)₂(bipy)₂]⁰

(D-70) [Rh(CN)₂(bipy)₂]⁰

(D-71) [RhCl₂(bipy)₃]⁰

(D-72) [RhCl₂(bipy)₂]⁰

(D-73) [Rh(phen)(bipy)₂]²⁺

(D-74) [Rh(NCS)₂(bipy)₂]⁰

(D-75) [Rh(NCS)₂(bipy)₂]⁰

In the foregoing group 8 metal compounds and group 8 metal complexes, abbreviation terms are as follows:

bipy: bipyridine bidendate ligand

bipy′: bipyridine monodendate ligand

im: imidazole

py: pyridine

phen: phenthroline

thia: thiazole

5-methylthia: 5-methylthiazole

In addition, bipyridine complexes described in JP-A No. 5-341426 are preferably usable.

Further to addition of at least a group 8 metal complex containing an aqua ligand and/or organic ligand in the preparation of silver halide grains, it is preferred to add a group 8 metal complex represented by the following formula:
Rₙ[MXₘY₆₋ₘ] Formula (A)
wherein M is a metal selected from group 8 elements of the periodical table (preferably iron, cobalt, ruthenium, iridium, rhodium, osmium and platinum, and more preferably iron, ruthenium, iridium, rhodium, osmium); R is an alkali metal (preferably cesium, sodium and potassium); m is an integer of 0 to 6, and n is an integer of 0 to 4; X and Y are each a ligand, including carbonyl ligand, fulminate ligand, thiocyanate ligand, nitrosyl ligand, thionitrosyl ligand, cyano ligand, aqua ligand, halogen ligand, ligands of ammonia, a hydroxide, nitrous acid, sulfurous acid and a peroxide ligands.

Specific examples of the group 8 metal compound and group 8 metal complex are shown below but are by no means limited to these. Any counter cation is usable, including potassium ion, calcium ion, sodium ion ammonium ion. Counter anions for the metal complex include nitrate ion, halide ion and perchlorate ion.

E-1: K₂[IrCl₆]

E-2: K₃[IrCl₆]

E-3: K₂[Ir(CN)₆]

E-4: K₃[Ir(CN)₆]

E-5: K₂[Ir(NO)((CN)₅)

E-6: K₂[IrBr₆]

E-7: K₃[IrBr₆]

E-8: K₂[IrBr₄Cl₂]

E-9: K₃[IrBr₄Cl₂]

E-10: K₂[IrBr₃Cl₃]

E-11: K₃[IrBr₃Cl₃]

E-12: K₂[IrBr₅Cl]

E-13: K₃[IrBrsCl]

E-14: K₂[IrBr₅I]

E-15: K₃[IrBrsI]

E-16: K₃[IrBr(CN)₅]

E-17: K₃[IrBr₂(CN)₄]

E-18: K₂[Ir(CN)₅(H₂O)]

E-19: K₃[Ir(CN)₅(H₂O)]

E-20: K[Ir(NO)Cl₅]

E-21: K[Ir(NS)Cl₅]

F-1: K₂[RUCl₆]

F-2: K₂[FeCl₆]

F-3: K₂[PtCl₆]

F-4: K₃[RhCl₆]

F-5: K₂[OsCl₆]

F-6: K₂[RuBr₆]

F-7: K₂[FeBr₆]

F-8: K₂[PtBr₆]

F-9: K₃[RhBr₆]

F-10: K₂[OsBr₆]

F-11: K₂[Pt(SCN)₄]

F-12: K₄[Ru(CNO)₆]

F-13: K₄[Fe(CNO)₆]

F-14: K₂[Pt(CNO)₄]

F-15: K₃[CO(NH₃)₆]

F-16: K₃[Co(CNO)₆]

F-17: K₄[Os(CNO)₆]

F-18: Cs₂[Os(NO)Cl₅]

F-19: K₂[Ru(NO)Cl₅]

F-20: K₂[Ru(CO)Cl₅]

F-21: Cs₂[Os(CO)Cl₅]

F-22: K₂[Fe(NO)Cl₅]

F-23: K₂[Ru(NO)Br₅]

F-24: K₂[Ru(NO)I₅]

F-25: K₂[Ru(NS)Cl₅]

F-26: K₂[Os(NS)Cl₅]

F-27: K₂[Ru(NS)Br₅]

F-28: K₂[Ru(NS)(SCN)₅]

F-29: K₂[RuBr₆]

F-30: K₂[FeBr₆]

F-31: K₄[Fe(CN)₆]

F-32: K₃[Fe(CN)₆]

F-33: K₄[Ru(CN)₆]

F-34: K₄[Os(CN)₆]

F-35: K₃[Rh(CN)₆]

F-36: K₄[RuCl(CN)₅]

F-37: K₄[OsBr(CN)₅]

F-38: K₄[OsCl(CN)₅]

F-39: K₃[RhF(CN)₅]

F-40: K₃[Fe(CO)(CN)₅]

F-41: K₄[RuF₂(CN)₄]

F-42: K₄[OsCl₂(CN)₄]

F-43: K₄[RhI₂(CN)₄]

F-44: K₄[Ru(CN)₅(OCN)]

F-45: K₄[Ru(CN)₅(N₃)₄]

F-46: K₄[Os(CN)₅(SCN)]

F-47: K₄[Rh(CN)₅(SeCN)]

F-48: K₄[RuF₂(CN)₄]

F-49: K₃[Fe(CN)₃Cl₃]

F-50: K₄[Os(CN)Cl₅]

F-51: K₃[Co(CN)₆]

F-52: K₂[RuBr(CN)₅]

F-53: K₂[Os(NS)( CN)₅1

F-54: K[Ru(NO)₂Cl₄]

F-55: K₄[Ru(CN)₅(N₃)₄]

F-56: K₂[Os(NS)Cl(SCN)₄]

F-57: K₂[Ru(NS)(I)₅]

F-58: K₂[Os(NS)Cl₄(TeCN)₄]

F-59: K₂[Rh(NS)Cl₅]

F-60: K₂[Ru(NO)(CN)₅]

F-61: K[Rh(NO)₂Cl₄]

F-62: K₂[Rh(NO)Cl₅]

To allow the foregoing Group 8 metal compounds to be included, doping may be conducted during physical ripening of silver halide grains or in the course of forming silver halide grains (in general, during addition of water-soluble silver salt and alkali halide). Alternatively, forming silver halide grains is interrupted and doping is carried out, then, the grain formation is continued. Doping can also be conducted by performing nucleation, physical ripening or grain formation in the presence of a Group 8 metal compound.

The Group 8 metal compound is used in an amount of 1×10⁻⁹ to 1×10⁻² mol, preferably 5×10⁻⁹ to 1×10⁻³ mol, and more preferably 1×10⁻⁸ to 1×10⁻⁴ mol per mol of silver halide. Commonly known methods of adding additives to a silver halide emulsion are applicable to allow the Group 8 metal compound to be included in silver halide grains, for example, the compound may be directly dispersed in an emulsion or incorporated through solution in solvents such as water, methanol and ethanol. A method of preparing a silver halide emulsion, in which fine silver halide grains including a Group 8 metal compound are added during grain formation can be referred to a method described in JP-A Nos. 11-212201 and 2000-89403.

Silver halide grain emulsions relating are preferably sensitized with selenium sensitizers. Labile selenium compounds capable of forming silver selenide upon reaction with aqueous silver nitrate are used as a selenium sensitizer. Examples thereof are described in U.S. Pat. Nos. 1,574,944, 1,602,592 and 1,623,499; JP-A Nos. 60-150046, 4-25832, 4-109240 and 4-147250. Examples of useful selenium sensitizers include colloidal selenium, isoselenocyanates (e.g., allyl isoselenocyanate), selenoureas (e.g., N,N-dimethylselenourea, N,N,N′-triethylselenourea, N,N,N′,N′-tetramethylselenourea, N,N,N′-trimethyl-N′-heptafluoropropylselenourea, N,N′-dimethyl-N,N′-bis(carboxymethyl)selenourea, N,N,N′-trimethyl-N′-heptafluoropropylcarbonylselenourea, N,N,N′-trimethyl-N′-4-nitrophenylcarbonylselenourea), selenoketones (e.g., selenoacetone, selenoacetophenone), selenoamides (e.g., selenoacetoamide, N,N-dimethylselenobenzamide), selenocarboxylic acids and selenoesters (e.g., 2-selenopropionic acid, methyl-3-selenobutylate), selenophosphates (e.g., tri-p-triselenophosphate, pentafluorophenyl-diphenylselenophosphate), and selenides (e.g., dimethylselenide, tributylphosphine selenide, triphenylphosphine selenide, tri-p-tolylphosphine selenide, pentafluorophenyl-diphenylphosphine selenide, trifurylphosphine selenide, tripyridylphosphine selenide) of these selenium sensitizers, selenoureas, selenoamides and selenides are preferred.

Specific examples of technique for using selenium sensitizers are described in U.S. Pat. Nos. 1,574,944, 1,602,592, 1,623,499, 3,297,466, 3,297447, 3,320,069, 3,408196, 3,408197, 3,442,653, 3,420,670, and 3,591,385; French Patent Nos. 2,693,038 and 2,093,209; JP-B Nos. 52-34491, 52-34492, 53-295 and57-22090; JP-A Nos. 59-180536, 59-185330, 59-181337, 59-187338, 59-192241, 60-150046, 60-151637, 61-246738, 3-4221, 3-24537, 3-111838, 3-116132, 3-148648, 3-237450, 4-16838, 4-25832, 4-32831, 4-33043, 4-96059, 4-109240, 4-140738, 4-140739, 4-147250, 4-184331, 4-190225, 4-191729, 4-195035, 5-11385, 5-40324, 5-24332, 5-24333, 5-30315, 5-306268, 6-306269, 6-27573, 6-75328, 6-175259, 6-208184, 6-208186, 6-317867, 7-92599, 7-98483, 7-104415, 7-140579, 7-301879, 7-301880, 8-114882, 9-19760, 9-138475, 9-166941, 9-138375, 9-189979, 10-10666 and 2001-343721; British Patent Nos. 255,846 and 861,984; and H. E. Spencer, Journal of Photographic Science, 31, 158-169 (1983).

A selenium sensitizer is added preferably in an amount of 1×10⁻⁹ to 1×10⁻¹ mol per mol of silver halide, and more preferably 1×10⁻⁸ to 1×10⁻² mol. Selenium sensitizers are added to a silver halide emulsion in such a manner that additives are usually incorporated to photographic emulsion. For example, a water-soluble compound is dissolved in water and a water-insoluble or sparingly water-soluble compound is dissolved in a water-miscible solvent exhibiting no adverse effect on photographic characteristics, such as alcohols, glycols, ketones, esters, and amides, and they are added in the form of solution.

Sulfur sensitizers may be used in combination with selenium sensitizers. Specific examples of preferred sulfur sensitizers include thiourea derivatives such as 1,3-diphenylthiourea, triethylthiourea and 1-ethyl-3-(2-thiazolyl)thiourea; rhodanine derivatives, dithiocarbamic acids, polysulfide organic compounds, thiosulfates, and simple substance of sulfur. Of simple substance of sulfur, rhombic α-sulfur is preferred. There are also usable sulfur sensitizers described in U.S. Pat. Nos. 1,574,944, 2,410,689, 2,278,947, 2,728,668, 3,501,313, and 3,656,955; West German Patent No. 1,422,869; JP-A Nos. 56-24937 and 55-45016.

There may be simultaneously used noble metal salts such as gold, platinum, palladium and iridium described in Research Disclosure (hereinafter, also denoted simply as RD). Of these, the use of a gold sensitizer is specifically preferred. Examples of useful gold sensitizers include chloroauric acid, gold thiosulfate, gold thiocyanic acid and organic gold compounds described in U.S. Pat. Nos. 2,597,856 and 5,049,485; JP-B No. 44-15748 and JP-A Nos. 1-147537 and 4-70650. When performing sensitization by using a gold complex, ligands for gold, such as a thiosulfate, thiocyanate, and thioether are preferably used as an auxiliary agent and the use of a thiocyanate is specifically preferred. The addition amount of a sulfur sensitizer or a gold sensitizer, depending on the kind of a silver halide grain emulsion, the kind of a used compound and ripening conditions, is preferably 1×10⁻⁹ to 1×10⁻⁵ mol per mol of silver halide, and more preferably 1×10⁻⁸ to 1×10⁻⁴ mol.

Various sensitizes described above may be added in accordance with properties of a sensitizer, for example, by solution in water or organic solvents such as methanol, by a mixture with a gelatin solution or by a method described in JP-A No. 4-140739, i.e., addition in the form of emulsified dispersion of a solution mixed with a polymer soluble in an organic solvent.

Reduction sensitizers may be further used and reducing compounds described in RD vol. 307, 307105 and JP-A No. 7-78685 are usable.

It is preferred that the silver halide emulsion of this invention includes a gelatin which contains substantially no calcium ion. The gelatin which contains substantially no calcium ion is one having a calcium content of 100 ppm or less, preferably 50 ppm or less, and more preferably 30 ppm or less. A gelatin which contains substantially no calcium ion can be obtained by a cationic deionization process with ion-exchange resins. A gelatin which contains substantially no calcium ion is preferably used in at least one of the processes of silver halide grain formation, desalting, dispersion, and chemical sensitization and/or spectral sensitization, and more preferably prior to chemical sensitization and/or spectral sensitization. A gelatin which contains substantially no calcium ion preferably accounts for at least 10% by weight of the whole dispersing medium of a prepared silver halide emulsion, more preferably at least 30%, and still more preferably at least 50%.

A chemically modified gelatin of which amino group is substituted is preferably used in the preparation of a silver halide emulsion of this invention to perform the formation and/or desalting of silver halide grains. Examples of such a chemically modified gelatin include modified gelatins described in JP-A Nos. 5-72658, 9-197595 and 9-251193 in which an amino group of gelatin has been substituted. The use of a chemically modified gelatin in the process of grain formation and/or desalting is preferably in an amount of at least 10% by weight of the whole dispersing medium, more preferably at least 30%, and still more preferably at least 50%. The substitution ratio of an amino group is preferably at least 30%, more preferably at least 50%, and still more preferably at least 80%.

Preferably, a silver halide emulsion is desalted after completion of grain formation. Desalting is conducted in such a manner, for example, as described in RD 17643, sect. II. Specifically, to remove unwanted soluble salts from a precipitation product or a physically ripened emulsion, a noodle washing method may be used, or inorganic salts, anionic surfactants or anionic polymers [e.g., poly(styrene sulfonic acid)] are also usable, but a flocculation method using gelatin derivatives or chemically modified gelatin (e.g., acylated gelatin and carbamoylated gelatin) and a ultrafiltration method employing membrane separation are preferred. The ultrafiltration method employing membrane separation is referred to “Kagaku Kogaku Binran (Handbook of Chemical Engineering)” 5th ed., page 924-954; RD vol. 102, 10208 and vol. 131, 13122; JP-B Nos. 59-43727 and 62-27008; JP-A Nos. 62-113137, 57-209823, 59-43727, 61-219948, 62-23035, 63-40137, 63-40039, 3-140946, 2-172816, 2-172817 and 4-22942. Ultrafiltration is conducted preferably employing an apparatus or a method described in JP-A Nos. 11-339923 and 11-231448.

Dispersing medium used in the preparation of silver halide emulsions is a compound exhibiting a protective colloid property for silver halide grains. Preferably, the dispersing medium is allowed to exist in the nucleation and growth stages of silver halide grain formation. Preferred dispersing mediums usable in this invention include gelatin and hydrophilic colloids. Preferred examples of gelatin usable in this invention include an alkali process or acid process gelatin having a molecular weight of ca. 100,000, an oxidized gelatin, and enzymatic process gelatin described in Bull. Soc. Sci. Photo. Japan No. 16, page 30 (1966). A gelatin an average molecular weight of 10,000 to 50,000 is preferably used in the nucleation stage of silver halide grains. To reduce the average molecular weight, gelatin is degraded by using a gelatin degradation enzyme or hydrogen peroxide. The use of a gelatin having a relatively low methionine content in the nucleation stage is preferred specifically in the preparation of tabular silver halide grains. The methionine content is preferably not more than 50 μmol per unit weight (g) of dispersing medium, and more preferably not more than 20 μmol. The methionine content can be reduced by subjecting gelatin to an oxidation treatment by using hydrogen peroxide and the like.

Examples of a hydrophilic colloid include gelatin derivatives, a graft polymer of gelatin with other polymers, proteins such as albumin or casein; cellulose derivatives such as hydroxyethyl cellulose, carboxymethyl cellulose, cellulose sulfuric acid esters; saccharide derivatives such as sodium alginate and starch derivatives and synthetic hydrophilic polymeric materials of homopolymers such as polyvinyl alcohol and its partial acetal, poly-N-vinylpyrrolidone, polyacrylic acid, polymethacrylic acid, polyacrylamide, polyvinylimidazole, and polyvinylpyrazole and their copolymers. Examples of usable gelatin usable include an alkali process gelatin, acid process gelatin, an oxidized gelatin, and enzymatic process gelatin described in Bull. Soc. Sci. Photo. Japan No. 16, page 30 (1966). There are also usable hydrolytic products and enzymatic degradation products of gelatin.

There can be employed a variety of apparatuses and methods for preparing silver halide emulsions, which are generally known in the art. The silver halide can be prepared according to any of acidic precipitation, neutral precipitation and ammoniacal precipitation. Silver halide grains can formed through a single process, or through forming seed grains and growing them. A process for preparing seed grains and a growing process thereof may be the same with or different from each other. Normal precipitation, reverse precipitation, double jet precipitation or a combination thereof is applicable as a reaction mode of a silver salt and halide salt, and the double jet precipitation is preferred. As one mode of the double jet precipitation is applicable a pAg-controlled double jet method described in JP-A 54-48521.

There can be employed a apparatus for supplying a silver salt aqueous solution and a halide aqueous solution through an adding apparatus provided in a reaction mother liquor, as described in JP-A 57-92523 and 57-92524; an apparatus for adding silver salt and halide solutions with continuously varying the concentration thereof, as described in German Patent 2,921,164; and an apparatus for forming grains in which a reaction mother liquor is taken out from the reaction vessel and concentrated by ultra-filtration to keep constant the distance between silver halide grains.

Solvents for silver halide such as thioethers are optionally employed. A compound containing a mercapto group, nitrogen containing heterocyclic compound or a compound such as a sensitizing dye can also be added at the time of forming silver halide grains or after completion thereof.

A antifoggant or a stabilizer known in the art are incorporated into the photographic material, for the purpose of preventing fog produced during the process of preparing the photographic material, reducing variation of photographic performance during storage or preventing fog produced in development. Examples of preferred compounds for the purpose include compounds represented by formula (II) described in JP-A 2-146036 at page 7, lower column.

These compounds are added in the step of preparing a silver halide emulsion, the chemical sensitization step or during the course of from completion of chemical sensitization to preparation of a coating solution. In cases when chemical sensitization is undergone in the presence of these compounds, the amount thereof is preferably 1×10⁻⁸ to 5×10⁻⁴ mole per mole of silver halide. In cases when added after chemical sensitization, the amount thereof is preferably 1×10⁻⁶ to 1×10⁻², and more preferably 1×10⁻⁵ to 5×10⁻³ mol per mole of silver halide. In cases when added at the stage of preparing a coating solution, the amount is preferably 1×10⁻⁶ to 1×10⁻¹, and more preferably 1×10⁻⁵ to 1×10⁻² mole per mol of silver halide. In case where added to a layer other than a silver halide emulsion layer, the amount is preferably 1×10⁻⁹ to 1×10⁻³ mole/m².

There are employed dyes having absorption at various wavelengths for anti-irradiation and anti-halation in the photographic material relating to the invention. A variety of dyes known in the art can be employed, including dyes having absorption in the visible range described in JP-A 3-251840 at page 30, AI-1 to 11, and JP-A No. 6-3770; infra-red absorbing dyes described in JP-A No. 1-280750 at page 2, left lower column, formula (I), (II) and (III). These dyes do not adversely affect photographic characteristics of a silver halide emulsion and there is no stain due to residual dyes. For the purpose of improving sharpness, the dye is preferably added in an amount that gives a reflection density at 680 nm of 0.7 to 3.0 and more preferably 0.8 to 3.0.

Fluorescent brightening agents are also incorporated into the photographic material to improve whiteness. Examples of preferred compounds include those represented by formula II described in JP-A No. 2-232652.

In cases when a silver halide photographic light sensitive material according to the invention is employed as a color photographic material, the photographic material comprises layer(s) containing silver halide emulsion(s) which are spectrally sensitized in the wavelength region of 400 to 900 nm, in combination with a yellow coupler, a magenta coupler and a cyan coupler. The silver halide emulsion contains one or more kinds of sensitizing dyes, singly or in combination thereof.

In the silver halide emulsions can be employed a variety of spectral-sensitizing dyes known in the art. Compounds BS-1 to 8 described in JP-A 3-251840 at page 28 are preferably employed as a blue-sensitive sensitizing dye. Compounds GS-1 to 5 described in JP-A 3-251840 at page 28 are preferably employed as a green-sensitive sensitizing dye. Compounds RS-1 to 8 described in JP-A 3-251840 at page 29 are preferably employed as a red-sensitive sensitizing dye. In cases where exposed to infrared ray with a semiconductor laser, infrared-sensitive sensitizing dyes are employed. Compounds IRS-1 to 11 described in JP-A 4-285950 at pages 6-8 are preferably employed as a blue-sensitive sensitizing dye. Supersensitizers SS-1 to SS-9 described in JP-A 4-285950 at pages 8-9 and compounds S-1 to S-17 described in JP-A 5-66515 at pages 5-17 are preferably included, in combination with these blue-sensitive, green-sensitive and red-sensitive sensitizing dyes. The sensitizing dye is added at any time during the course of silver halide grain formation to completion of chemical sensitization. The sensitizing dye is incorporated through solution in water-miscible organic solvents such as methanol, ethanol, fluorinated alcohol, acetone and dimethylformamide or water, or in the form of solid particle dispersion.

As couplers used in silver halide photographic materials relating to the invention is usable any compound capable of forming a coupling product exhibiting an absorption maximum at the wavelength of 340 nm or longer, upon coupling with an oxidation product of a developing agent. Representative examples thereof include yellow dye forming couplers exhibiting an absorption maximum at the wavelength of 350 to 500 nm, magenta dye forming couplers exhibiting an absorption maximum at the wavelength of 500 to 600 nm and cyan dye forming couplers exhibiting an absorption maximum at the wavelength of 600 to 750 nm.

Examples of preferred cyan couplers include those which are represented by general formulas (C-I) and (C-II) described in JP-A 4-114154 at page 5, left lower column. Exemplary compounds described therein (page 5, right lower column to page 6, left lower column) are CC-1 to CC-9.

Examples of preferred magenta couplers include those which are represented by general formulas (M-I) and (M-II) described in JP-A No. 4-114154 at page 4, right upper column. Exemplary compounds described therein (page 4, left lower column to page 5, right upper column) are MC-1 to MC-11. Of these magenta couplers are preferred couplers represented by formula (M-I) described in ibid, page 4, right upper column; and couplers in which RM in formula (M-I) is a tertiary alkyl group are specifically preferred. Further, couplers MC-8 to MC-11 are superior in color reproduction of blue to violet and red, and in representation of details.

Examples of preferred yellow couplers include those which are represented by general formula (Y-I) described in JP-A No. 4-114154 at page 3, right upper column. Exemplary compounds described therein (page 3, left lower column) are YC-1 to YC-9. Of these yellow couplers are preferred couplers in which RY1 in formula (Y-I) is an alkoxy group are specifically preferred or couplers represented by formula [I] described in JP-A No. 6-67388. Specifically preferred examples thereof include YC-8 and YC-9 described in JP-A No. 4-114154 at page 4, left lower column and Nos. (1) to (47) described in JP-A No. 6-67388 at pages 13-14. Still more preferred examples include compounds represented by formula [Y-1] described in JP-A No. 4-81847 at page 1 and pages 11-17.

When an oil-in-water type-emulsifying dispersion method is employed for adding couplers and other organic compounds used for the photographic material of the present invention, in a water-insoluble high boiling organic solvent, whose boiling point is 150° C. or more, a low boiling and/or a water-soluble organic solvent are combined if necessary and dissolved. In a hydrophilic binder such as an aqueous gelatin solution, the above-mentioned solutions are emulsified and dispersed by the use of a surfactant. As a dispersing means, a stirrer, a homogenizer, a colloidal mill, a flow jet mixer and a supersonic dispersing machine may be used. Preferred examples of the high boiling solvents include phthalic acid esters such as dioctyl phthalate, diisodecyl phthalate, and dibutyl phthalate; and phosphoric acid esters such as tricresyl phosphate and trioctyl phosphate. High boiling solvents having a dielectric constant of 3.5 to 7.0 are also preferred. These high boiling solvents may be used in combination. Instead of or in combination with the high boiling solvent is employed a water-insoluble and organic solvent-soluble polymeric compound, which is optionally dissolved in a low boiling and/or water-soluble organic solvent and dispersed in a hydrophilic binder such as aqueous gelatin using a surfactant and various dispersing means. In this case, examples of the water-insoluble and organic solvent-soluble polymeric compound include poly(N-t-butylacrylamide).

As a surfactant used for adjusting surface tension when dispersing or coating photographic additives, the preferable compounds are those containing a hydrophobic group having 8 through 30 carbon atoms and a sulfonic acid group or its salts in a molecule. Exemplary examples thereof include A-1 through A-11 described in JP-A No. 64-26854. In addition, surfactants, in which a fluorine atom is substituted to an alkyl group, are also preferably used. The dispersion is conventionally added to a coating solution containing a silver halide emulsion. The elapsed time from dispersion until addition to the coating solution and the time from addition to the coating solution until coating are preferably short. They are respectively preferably within 10 hours, more preferably within 3 hours and still more preferably within 20 minutes.

To each of the above-mentioned couplers, to prevent color fading of the formed dye image due to light, heat and humidity, an anti-fading agent may be added singly or in combination. The preferable compounds or a magenta dye are phenyl ether type compounds represented by Formulas I and II in JP-A No. 2-66541, phenol type compounds represented by Formula IIIB described in JP-A No. 3-174150, amine type compounds represented by Formula A described in JP-A No. 64-90445 and metallic complexes represented by Formulas XII, XIII, XIV and XV described in JP-A No. 62-182741. The preferable compounds to form a yellow dye and a cyan dye are compounds represented by Formula I′ described in JP-A No. 1-196049 and compounds represented by Formula II described in JP-A No. 5-11417.

A compound (d-11) described in JP-A No. 4-114154 at page 9, left lower column and a compound (A′-1) described in the same at page 10, left lower column are also employed for allowing the absorption wavelengths of a dye to shift. Besides can also be employed a compound capable of releasing a fluorescent dye described in U.S. Pat. No. 4,774,187.

It is preferable that a compound reacting with the oxidation product of a color developing agent be incorporated into a layer located between light-sensitive layers for preventing color staining and that the compound is added to the silver halide emulsion layer to decrease fogging. As a compound for such purposes, hydroquinone derivatives are preferable, and dialkylhydroquinone such as 2,5-di-t-octyl hydroquinone are more preferable. The specifically preferred compound is a compound represented by Formula II described in JP-A No. 4-133056, and compounds II-1 through II-14 described in the above-mentioned specification pp. 13 through 14 and compound 1 described on page 17.

In the photographic material according to the present invention, it is preferable that static fogging is prevented and light-durability of the dye image is improved by adding a UV absorber. The preferable UV absorbent is benzotriazoles. The specifically preferable compounds are those represented by Formula III-3 in JP-A No. 1-250944, those represented by Formula III described in JP-A No. 64-66646, UV-1L through UV-27L described in JP-A No. 63-187240, those represented by Formula I described in JP-A No. 4-1633 and those represented by Formulas (I) and (II) described in JP-A No. 5-165144.

In the photographic materials used in the invention is advantageously employed gelatin as a binder. Furthermore, there can be optionally employed other hydrophilic colloidal materials, such as gelatin derivatives, graft polymers of gelatin with other polymers, proteins other than gelatin, saccharide derivatives, cellulose derivatives and synthetic hydrophilic polymeric materials. A vinylsulfone type hardening agent or a chlorotriazine type hardening agent is employed as a hardener of the binder, and compounds described in JP-A 61-249054 and 61-245153 are preferably employed. An antiseptic or antimold described in JP-A 3-157646 is preferably incorporated into a hydrophilic colloid layer to prevent the propagation of bacteria and mold which adversely affect photographic performance and storage stability of images. A lubricant or a matting agent is also preferably incorporated to improve surface physical properties of raw or processed photographic materials.

A variety of supports are employed in the photographic material used in this invention, including paper coated with polyethylene or polyethylene terephthalate, paper support made from natural pulp or synthetic pulp, polyvinyl chloride sheet, polypropylene or polyethylene terephthalate supports which may contain a white pigment, and baryta paper. Of these supports a paper support coated, on both sides, with water-proof resin layer. As the water-proof resin are preferably employed polyethylene, ethylene terephthalate and a copolymer thereof. Inorganic and/or organic white pigments are employed, and inorganic white pigments are preferably employed. Examples thereof include alkaline earth metal sulfates such as barium sulfate, alkaline earth metal carbonates such as calcium carbonate, silica such as fine powdery silicate and synthetic silicate, calcium silicate, alumina, alumina hydrate, titanium oxide, zinc oxide, talc, and clay. Preferred examples of white pigments include barium sulfate and titanium oxide. The amount of the white pigment to be added to the water-proof resin layer on the support surface is preferably not less than 13% by weight, and more preferably not less than 15% by weight to improve sharpness. The dispersion degree of a white pigment in the water-proof resin layer of paper support can be measured in accordance with the procedure described in JP-a 2-28640. In this case, the dispersion degree, which is represented by a coefficient of variation, is preferably not more than 020, and more preferably not more than 0.15.

Supports having a center face roughness (Sra) of 0.15 nm or less (preferably, 0.12 nm or less) are preferably employed in terms of glossiness. Trace amounts of a blueing agent or reddening agent such as ultramarine or oil-soluble dyes are incorporated in a water-proof resin layer containing a white pigment or hydrophilic layer(s) of a reflection support to adjust the balance of spectral reflection density in a white portion of processed materials and improve its whiteness. The surface of the support may be optionally subjected to corona discharge, UV light exposure or flame treatment and further thereon, directly or through a sublayer (i.e., one or more sublayer for making improvements in surface properties of the support, such as adhesion property, antistatic property, dimensional stability, friction resistance, hardness, anti halation and/or other characteristics), are coated component layers of the photographic material relating to the invention. In coating of the photographic material, a thickening agent may be employed to enhance coatability of a coating solution. As a coating method are useful extrusion coating and curtain coating, in which two or more layers are simultaneously coated.

To form photographic images using a photographic material relating to the invention, an image recorded on the negative can optically be formed on a photographic material to be printed. Alternatively, the image is converted to digital information to form the image on a CRT (anode ray tube), and the resulting image can be formed on a photographic material to be printed by projecting or scanning with varying the intensity and/or exposing time of laser light, based on the digital information.

It is preferable to apply the present invention to a photographic material wherein a developing agent is not incorporated in the photographic material. Examples of such a photographic material include color paper, color reversal paper, positive image forming photographic material, photographic material used for display, and photographic material used for color proof. Application to photographic material having a reflective support is specifically preferred.

Commonly known aromatic primary amine developing agents are employed in the invention. Examples thereof include:

CD-1) N,N-diethyl-p-phenylendiamine,

CD-2) 2-amino-5-diethylaminotoluene,

CD-3) 2-amino-5-(N-ethyl-N-laurylamino)toluene,

CD-4) 4-(N-ethyl-N-(β-hydroxyethyl)amino)-aniline,

CD-5) 2-methyl-4-(N-ethyl-N-(β-hydroxyethyl)amino)aniline,

CD-6) 4-amino-3-methyl-N-ethyl-N-(β-methanesulfoneamido-ethyl)aniline,

CD-7) 4-amino-3-β-methanesulfoneamidoethyl-N,N-diethyl-aniline

CD-8) N,N-dimethyl-p-phenylenediamine,

CD-9) 4-amino-3-methyl-N-ethyl-N-metoxyethylaniline,

CD-10) 4-amino-3-methyl-N-ethyl-N-(β-ethoxyethyl)aniline,

CD-11) 4-amino-3-methyl-N-ethyl-N-(γ-hydroxypropyl)-aniline.

The pH of a color developing solution is optional, but preferably 9.5 to 13.0, and more preferably 9.8 to 12.0 in terms of rapid access. The higher color development temperature enables more rapid access, but the temperature is preferably 35 to 70° C., and more preferably 37 to 60° C. in terms of stability of processing solutions. The color developing time is conventionally 3 min. 30 sec. but the developing time in the invention is preferably not longer than 40 sec., and more preferably not longer than 25 sec. In addition to the developing agents described above, the developing solution is added with commonly known developer component compounds, including an alkaline agent having pH-buffering action, a development inhibiting agent such as chloride ion or benzotriazole, a preservative, and a chelating agent.

In the image forming method according to the invention, photographic materials, after color-developed, may be optionally subjected to bleaching and fixing. The bleaching and fixing may be carried out currently. After fixing, washing is conventionally carried out. Stabilizing may be conducted in place of washing. As a processing apparatus used in the invention is applicable a roller transport type processor in which a photographic material is transported with being nipped by rollers and an endless belt type processor in which a photographic material is transported with being fixed in a belt. Further thereto are also employed a method in which a processing solution supplied to a slit-formed processing bath and a photographic material is transported therethrough, a spraying method, a web processing method by contact with a carrier impregnated with a processing solution and a method by use of viscous processing solution. A large amount of photographic materials are conventionally processed using an automatic processor. In this case, the less replenishing rate is preferred and an environmentally friendly embodiment of processing is replenishment being made in the form of a solid tablet, as described in KOKAI-GIHO (Disclosure of Techniques) 94-16935.

Photographic material used for print, relating to this invention exhibits markedly improved image quality when exposed through negative film having an area of 3 to 7 cm² per picture element to form images. The negative film may be one having an information recording ability.

### EXAMPLES

The present invention will be further described based on examples but are by no means limited to these examples.

### Example 1

### Preparation of Silver Halide Emulsion

Silver halide emulsions were prepared in the following manner.

Preparation of Silver Halide Emulsion (B-1)

To 1 liter of an aqueous 2% solution of deionized ossein gelatin (containing 10 ppm calcium), maintained at 40° C. were solutions (A1) and (B1) for 20 min, while controlling the pAg and pH at 7.3 and 3.0, respectively. Subsequently, solutions (A2) and (B2) were added for 90 min with controlling the pAg and pH at 8.0 and 5.5, respectively. Solution (C1) was added, and then, solutions (A3) and (B3) were added over 15 min. with controlling the pAg and pH at 8.0 and 5.5, respectively. The pAg was controlled in accordance with the method described in JP-A No. 59-45437 and the pH was controlled using aqueous sulfuric acid or sodium hydroxide solution.

| Solution (A1) | | |
|---|---|---|
| Sodium chloride | 3.42 | g |
| Potassium bromide | 0.03 | g |
| Water to make | 200 | ml |
| Solution (A2) | | |
| Sodium chloride | 71.9 | g |
| K₂[IrCl₆] | 3.0 × 10⁻⁸ | mol/mol AgX |
| K₂[IrBr₆] | 1.0 × 10⁻⁸ | mol/mol AgX |
| K₄[Fe(CN)₆] | 2.0 × 10⁻⁵ | mol/mol AgX |
| Potassium bromide | 0.76 | g |
| Water to make | 420 | ml |
| Solution (A3) | | |
| Sodium chloride | 30.8 | g |
| Potassium bromide | 0.3 | g |
| Water to make | 180 | ml |
| Solution (B1) | | |
| Silver nitrate | 10 | g |
| Water to make | 200 | ml |
| Solution (B2) | | |
| Silver nitrate | 210 | g |
| Water to make | 420 | ml |
| Solution (B3) | | |
| Silver nitrate | 90 | g |
| Water to make | 180 | ml |
| Solution (C1) | | |
| Potassium iodide | 0.12 | g |
| Water to make | 5.0 | ml |

After completing addition, an aqueous 5% solution containing 30 g of chemically modified gelatin (modification rate of 95%), in which an amino group of gelatin was phenylcarbamoylated, was added to perform desalting in accordance with the method described in JP-A No. 5-72658, and an aqueous gelatin solution was further added thereto to obtain silver halide emulsion (B-1) comprising monodisperse cubic grains having an average grain size (equivalent cubic edge length) of 0.50 μm.

Preparation of Silver Halide Emulsion (B-2)

To 1 liter of an aqueous 2% solution of deionized ossein gelatin (containing 10 ppm calcium), maintained at 40′ C. were solutions (A4) and (B4) for 20 min, while controlling the pAg and pH at 7.3 and 3.0, respectively. Subsequently, solutions (A5) and (B5) were added for 90 min with controlling the pAg and pH at 8.0 and 5.5, respectively. Solution (C2) was added, and then, solutions (A6) and (B6) were added over 15 min. with controlling the pAg and pH at 8.0 and 5.5, respectively. When 30% of the solution (B6) was added, solution (D2) was added. The pAg was controlled in accordance with the method described in JP-A No. 59-45437 and the pH was controlled using aqueous sulfuric acid or sodium hydroxide solution.

| Solution (A4) | | |
|---|---|---|
| Sodium chloride | 3.43 | g |
| Water to make | 200 | ml |
| Solution (A5) | | |
| Sodium chloride | 72.3 | g |
| K₂[IrCl₆] | 3.0 × 10⁻⁸ | mol/mol AgX |
| K₂[IrBr₆] | 1.0 × 10⁻⁸ | mol/mol AgX |
| K₄[Fe(CN)₆] | 2.0 × 10⁻⁵ | mol/mol AgX |
| Water to make | 420 | ml |
| Solution (A6) | | |
| Sodium chloride | 30.9 | g |
| Water to make | 180 | ml |
| Solution (B4) | | |
| Silver nitrate | 10 | g |
| Water to make | 200 | ml |
| Solution (B5) | | |
| Silver nitrate | 210 | g |
| Water to make | 420 | ml |
| Solution (B6) | | |
| Silver nitrate | 90 | g |
| Water to make | 180 | ml |
| Solution (C2) | | |
| Potassium iodide | 0.12 | g |
| Water to make | 5.0 | ml |
| Solution (D2) | | |
| Potassium bromide | 2.61 | g |
| Water to make | 11.0 | ml |

After completing addition, an aqueous 5% solution containing 30 g of chemically modified gelatin (modification rate of 95%), in which an amino group of gelatin was phenylcarbamoylated, was added to perform desalting in accordance with the method described in JP-A No. 5-72658, and an aqueous gelatin solution was further added thereto to obtain silver halide emulsion (B-2) comprising monodisperse cubic grains having an average grain size (equivalent cubic edge length) of 0.50 μm.

Preparation of Silver Halide Emulsion (B-3)

Silver halide emulsion (B-3) was prepared similarly to the foregoing silver halide emulsion (B-2), except that the solution (C2) was replaced by the following solution (C3). The obtained emulsion (B-3) was comprised of monodisperse cubic grains having an average grain size (equivalent cubic edge length) of 0.50 μm.

Solution (C3)

| | | |
|---|---|---|
| Potassium iodide | 0.12 | g |
| Water to make | 100.0 | ml |

Preparation of Silver Halide Emulsion (B-4)

Silver halide emulsion (B-4) was prepared similarly to the foregoing silver halide emulsion (B-3), except that the solution (C3) was replaced by the following solution (E1), the pH was adjusted to 9.0 with an aqueous potassium hydroxide solution and after 3 min., the pH was again adjusted to 5.5 with sulfuric acid, then, the solutions (A6) and (B6) were added. The obtained emulsion (B-4) was comprised of monodisperse cubic grains having an average grain size (equivalent cubic edge length) of 0.50 μm.

| Solution (E1) | | |
|---|---|---|
| Iodide ion-releasing agent 21 | 8 × 10⁻⁵ | mol |
| Water to make | 20.0 | ml |
| Iodide ion-releasing agent 21 | | |
| 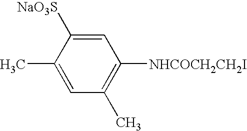 | | |

Preparation of Silver Halide Emulsion (B-5)

Silver halide emulsion (B-5) was prepared similarly to the foregoing silver halide emulsion (B-4), except that the solution (D2) was replaced by the following solution (D3). The obtained emulsion (B-5) was comprised of monodisperse cubic grains having an average grain size (equivalent cubic edge length) of 0.50 μm.

Solution (D3)

| | | |
|---|---|---|
| Potassium bromide | 5.44 | g |
| Water to make | 23.0 | ml |

Preparation of Silver Halide Emulsion (B-6)

Silver halide emulsion (B-6) was prepared similarly to the foregoing silver halide emulsion (B-5), except that the solution (E1) was replaced by the following solution (E2). The obtained emulsion (B-6) was comprised of monodisperse cubic grains having an average grain size (equivalent cubic edge length) of 0.50 μm.

Solution (E2)

| Iodide ion-releasing agent 21 | 2 × 10⁻⁴ | mol |
|---|---|---|
| Water to make | 50.0 | ml |

Preparation of Silver Halide Emulsion (B-7)

Silver halide emulsion (B-7) was prepared similarly to the foregoing silver halide emulsion (B-6), except that the solution (D3) was replaced by the following solution (D4). The obtained emulsion (B-7) was comprised of monodisperse cubic grains having an average grain size (equivalent cubic edge length) of 0.50 μm.

Solution (D4)

| | | |
|---|---|---|
| Potassium bromide | 5.44 | g |
| Water to make | 137.0 | ml |

Preparation of Silver Halide Emulsion (B-8)

Silver halide emulsion (B-8) was prepared similarly to the foregoing silver halide emulsion (B-7), except that the solution (A5) was replaced by the following solution (A7). The obtained emulsion (B-8) was comprised of monodisperse cubic grains having an average grain size (equivalent cubic edge length) of 0.50 μm.

Solution (A7)

| | | |
|---|---|---|
| Sodium chloride | 72.3 | g |
| K₂[IrCl₆] | 8.0 × 10⁻⁹ | mol/mol AgX |
| K₂[IrBr₆] | 5.0 × 10⁻⁹ | mol/mol AgX |
| K₂[IrCl₅(H₂O)] | 9.0 × 10⁻⁸ | mol/mol AgX |
| K₂[IrCl₅(thiazole)] | 5.0 × 10⁻⁹ | mol/mol AgX |
| K₄[Fe(CN)₆] | 2.0 × 10⁻⁵ | mol/mol AgX |
| Water to make | 420 | ml |

Preparation of Silver Halide Emulsion (B-9)

Silver halide emulsion (B-9) was prepared similarly to the foregoing silver halide emulsion (B-7), except that the solution (A5) was replaced by the following solution (A8). The obtained emulsion (B-9) was comprised of monodisperse cubic grains having an average grain size (equivalent cubic edge length) of 0.50 μm.

Solution (A8)

| | | |
|---|---|---|
| Sodium chloride | 72.3 | g |
| K₂[IrCl₆] | 7.0 × 10⁻⁹ | mol/mol AgX |
| K₂[IrBr₆] | 5.0 × 10⁻⁹ | mol/mol AgX |
| K₂[IrCl₅(H₂O)] | 1.0 × 10⁻⁷ | mol/mol AgX |
| K₂[IrBr₅(H₂O)] | 9.0 × 10⁻⁹ | mol/mol AgX |
| K₂[IrCl₅(thiazole)] | 3.0 × 10⁻⁹ | mol/mol AgX |
| K₄[Ru(CN)₆] | 2.0 × 10⁻⁵ | mol/mol AgX |
| Water to make | 420 | ml |

Preparation of Silver Halide Emulsions (G-1) to (G-9)

Silver halide emulsions (G-1) to (G-9) were prepared similarly to the foregoing silver halide emulsions (B-1) to (B-9), respectively, except that the addition time of solutions (A1), (A2), (A3), (A4), (A5), (A6), (A7), (A8), (B1), (B2), (B3), (B4), (B5) and (B6) was varied. The obtained silver halide emulsions (G-1) to (G-9) were each comprised of monodisperse cubic grains having an average grain size (equivalent cubic edge length) of 0.35 μm.

Preparation of Silver Halide Emulsions (R-1) to (R-9)

Silver halide emulsions (R-1) to (R-9) were prepared similarly to the foregoing silver halide emulsions (B-1) to (B-9), respectively, except that the addition time of solutions (A1), (A2), (A3), (A4), (A5), (A6), (A7), (A8), (B1), (B2), (B3), (B4), (B5) and (B6) was varied. The obtained silver halide emulsions (R-1) to (R-9) were each comprised of monodisperse cubic grains having an average grain size (equivalent cubic edge length) of 0.30 μm.

Characteristics of silver halide emulsions (B-1) to (B-9), (G-1) to (G-9) and (R-1) to (R-9) are shown in Table 1.

It was proved that in each of the foregoing emulsions, the silver halide grains exhibited an average aspect ratio of 1.13 and more than 50% by number of the silver halide grains was accounted for by grains having a chloride content of not less than 90 mol %, an iodide content of from 0.02 to 2 mol % and a bromide content of from 0.1 to 9 mol %.

TABLE 1

| | Average | | Average | Average | Average | | | | |
|---|---|---|---|---|---|---|---|---|---|
| | Grain | | Chloride | Bromide | Iodide | Average | | | |
| | Size | | Content | Content | Content | Aspect | CV-2*² | CV-3*³ | |
| Emulsion | (μm) | CV-1*¹ | (mol %) | (mol %) | (mol %) | Ratio | (%) | (%) | Remark |
| B-1 | 0.50 | 0.07 | 99.46 | 0.5 | 0.04 | 1.13 | 47 | 33 | Comp. |
| B-2 | 0.50 | 0.07 | 99.46 | 0.5 | 0.04 | 1.13 | 46 | 36 | Comp. |
| B-3 | 0.50 | 0.07 | 98.76 | 1.2 | 0.04 | 1.13 | 35 | 36 | Inv. |
| B-4 | 0.50 | 0.07 | 98.76 | 1.2 | 0.04 | 1.13 | 25 | 34 | Inv. |
| B-5 | 0.50 | 0.07 | 97.46 | 2.5 | 0.04 | 1.13 | 25 | 33 | Inv. |
| B-6 | 0.50 | 0.07 | 97.4 | 2.5 | 0.1 | 1.13 | 24 | 35 | Inv. |
| B-7 | 0.50 | 0.07 | 97.4 | 2.5 | 0.1 | 1.13 | 18 | 17 | Inv. |
| B-8 | 0.50 | 0.07 | 97.4 | 2.5 | 0.1 | 1.13 | 18 | 17 | Inv. |
| B-9 | 0.50 | 0.07 | 97.4 | 2.5 | 0.1 | 1.13 | 18 | 17 | Inv. |
| G-1 | 0.35 | 0.07 | 99.46 | 0.5 | 0.04 | 1.13 | 47 | 35 | Comp. |
| G-2 | 0.35 | 0.07 | 99.46 | 0.5 | 0.04 | 1.13 | 47 | 36 | Comp. |
| G-3 | 0.35 | 0.07 | 98.76 | 1.2 | 0.04 | 1.13 | 37 | 36 | Inv. |
| G-4 | 0.35 | 0.07 | 98.76 | 1.2 | 0.04 | 1.13 | 27 | 35 | Inv. |
| G-5 | 0.35 | 0.07 | 97.46 | 2.5 | 0.04 | 1.13 | 27 | 34 | Inv. |
| G-6 | 0.35 | 0.07 | 97.4 | 2.5 | 0.1 | 1.13 | 25 | 32 | Inv. |
| G-7 | 0.35 | 0.07 | 97.4 | 2.5 | 0.1 | 1.13 | 18 | 17 | Inv. |
| G-8 | 0.35 | 0.07 | 97.4 | 2.5 | 0.1 | 1.13 | 18 | 17 | Inv. |
| G-9 | 0.35 | 0.07 | 97.4 | 2.5 | 0.1 | 1.13 | 18 | 17 | Inv. |
| R-1 | 0.30 | 0.08 | 99.46 | 0.5 | 0.04 | 1.13 | 48 | 36 | Comp. |
| R-2 | 0.30 | 0.08 | 99.46 | 0.5 | 0.04 | 1.13 | 47 | 39 | Comp. |
| R-3 | 0.30 | 0.08 | 98.76 | 1.2 | 0.04 | 1.13 | 37 | 37 | Inv. |
| R-4 | 0.30 | 0.08 | 98.76 | 1.2 | 0.04 | 1.13 | 27 | 36 | Inv. |
| R-5 | 0.30 | 0.08 | 97.46 | 2.5 | 0.04 | 1.13 | 27 | 33 | Inv. |
| R-6 | 0.30 | 0.08 | 97.4 | 2.5 | 0.1 | 1.13 | 25 | 33 | Inv. |
| R-7 | 0.30 | 0.08 | 97.4 | 2.5 | 0.1 | 1.13 | 19 | 19 | Inv. |
| R-8 | 0.30 | 0.08 | 97.4 | 2.5 | 0.1 | 1.13 | 19 | 19 | Inv. |
| R-9 | 0.30 | 0.08 | 97.4 | 2.5 | 0.1 | 1.13 | 19 | 19 | Inv. |

*¹coefficient of variation in grain size among grains
*²coefficient of variation in iodide content among grains
*³coefficient of variation in bromide content among grains

Preparation of Blue-Sensitive Emulsions (B-1a) to (B-9a)

To the foregoing silver halide emulsions (B-1) to (B-9), sensitizing dyes (BS-1) and (BS-2) were added at 60° C., a pH of 5.8 and a pAg of 7.5, subsequently, sodium thiosulfate and chloroauric acid were added to perform spectral sensitization and chemical sensitization. Following the addition of chemical sensitizers and when optimally ripened, compounds (S-2-5), (S-2-2), (S-2-3) and (4-6) were successively added to stop ripening. Blue-sensitive silver halide emulsions (B-1a) to (B-9a) were thus obtained.

| | |
|---|---|
| Sodium thiosulfate | 6.5 × 10⁻⁶ mol/mol AgX |
| Chloroauric acid | 1.9 × 10⁻⁵ mol/mol AgX |
| Compound S-2-5 | 2.0 × 10⁻⁴ mol/mol AgX |
| Compound S-2-2 | 2.0 × 10⁻⁴ mol/mol AgX |
| Compound S-2-3 | 2.0 × 10⁻⁴ mol/mol AgX |
| Compound (1-21) | 1.5 × 10⁻⁵ mol/mol AgX |
| Compound (4-6) | 1.5 × 10⁻⁵ mol/mol AgX |
| Sensitizing dye BS-1 | 5.2 × 10⁻⁴ mol/mol AgX |
| Sensitizing dye BS-2 | 1.3 × 10⁻⁴ mol/mol AgX |

S-2-2

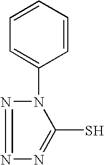

S-2-3

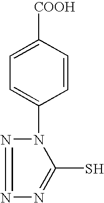

S-2-5

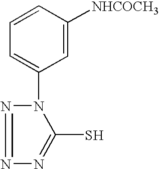

(1-21)

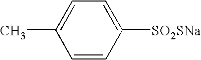

(4-6)

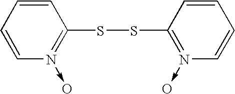

BS-1

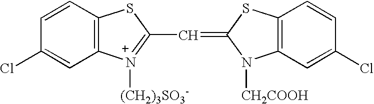

BS-2

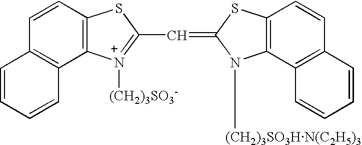

GS-1

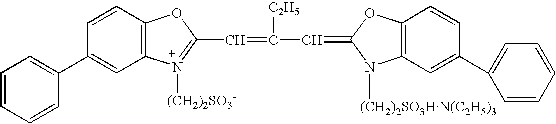

RS-1

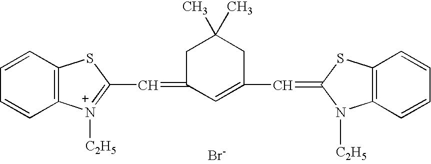

RS-2

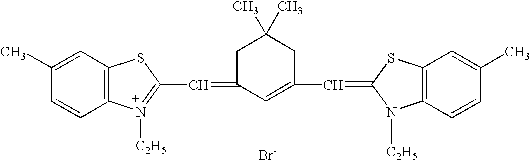

SS-1

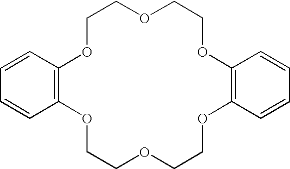

Preparation of Blue-Sensitive Emulsion (B-9b)

To the foregoing silver halide emulsion (B-9), sensitizing dyes (BS-1) and (BS-2) were added at 60° C., a pH of 5.8 and a pAg of 7.5, subsequently, the following compound (1-21), sodium thiosulfate, trifurylphosphine selenide and chloroauric acid were added to perform spectral sensitization and chemical sensitization. Following the addition of chemical sensitizers and when optimally ripened, compounds (S-2-5), (S-2-2), (S-2-3) and (4-6) were successively added to stop ripening. A blue-sensitive silver halide emulsion (B-9b) was thus obtained.

| | | |
|---|---|---|
| Sodium thiosulfate | 3.9 × 10⁻⁶ | mol/mol AgX |
| Trifurylphosphine selenide | 2.6 × 10⁻⁶ | mol/mol Ag |
| Chloroauric acid | 1.9 × 10⁻⁵ | mol/mol AgX |
| Compound S-2-5 | 2.0 × 10⁻⁴ | mol/mol AgX |
| Compound S-2-2 | 2.0 × 10⁻⁴ | mol/mol AgX |
| Compound S-2-3 | 2.0 × 10⁻⁴ | mol/mol AgX |
| Compound (1-21) | 1.5 × 10⁻⁵ | mol/mol AgX |
| Compound (4-6) | 1.5 × 10⁻⁵ | mol/mol AgX |
| Sensitizing dye BS-1 | 5.2 × 10⁻⁴ | mol/mol AgX |
| Sensitizing dye BS-2 | 1.3 × 10⁻⁴ | mol/mol AgX |

Preparation of Green-Sensitive Emulsions (G-1a) to (G-9a)

To each of the foregoing silver halide emulsions (G-1) to (G-9), sensitizing dye (GS-1) was added at 60° C., a pH of 5.8 and a pAg of 7.5 and subsequently, the following compound (1-21), sodium thiosulfate and chloroauric acid were successively added to perform spectral sensitization and chemical sensitization. Following addition of the chemical sensitizers and when optimally ripened, compound (S-2-5) and compound (4-6) were added to stop ripening. Green-sensitive silver halide emulsions (G-1a) to (G-9a) were thus obtained.

| | | |
|---|---|---|
| Sensitizing dye GS-1 | 4.0 × 10⁻⁴ | mol/mol AgX |
| Sodium thiosulfate | 5.5 × 10⁻⁶ | mol/mol AgX |
| Chloroauric acid | 1.5 × 10⁻⁵ | mol/mol AgX |
| Compound S-2-5 | 1.5 × 10⁻⁴ | mol/mol AgX |
| Compound (1-21) | 2.0 × 10⁻⁵ | mol/mol AgX |
| Compound (4-6) | 2.0 × 10⁻⁵ | mol/mol AgX |

Preparation of Green-Sensitive Emulsion (G-9b)

To the foregoing silver halide emulsion (G-9), sensitizing dye (GS-1) was added at 60° C., a pH of 5.8 and a pAg of 7.5 and subsequently, the compound (1-21), sodium thiosulfate, trifury;phosphine selenide and chloroauric acid were successively added to perform spectral sensitization and chemical sensitization. Following addition of the chemical sensitizers and when optimally ripened, compound (S-2-5) and compound (4-6) were added to stop ripening. A green-sensitive silver halide emulsion (G-9b) was thus obtained.

| | | |
|---|---|---|
| Sensitizing dye GS-1 | 4.0 × 10⁻⁴ | mol/mol AgX |
| Sodium thiosulfate | 3.3 × 10⁻⁶ | mol/mol AgX |
| Trifurylphosphine selenide | 2.2 × 10⁻⁶ | mol/mol Ag |
| Chloroauric acid | 1.5 × 10⁻⁵ | mol/mol AgX |
| Compound S-2-5 | 1.5 × 10⁻⁴ | mol/mol AgX |
| Compound (1-21) | 2.0 × 10⁻⁵ | mol/mol AgX |
| Compound (4-6) | 2.0 × 10⁻⁵ | mol/mol AgX |

Preparation of Red-Sensitive Emulsions (R-1a) to (R-9a)

To each of the foregoing silver halide emulsions (R-1) to (R-9), sensitizing dyes (RS-1) and (RS-2) were added at 60° C., a pH of 5.0 and a pAg of 7.1 and subsequently, the following compound (1-21), sodium thiosulfate and chloroauric acid were added to perform spectral sensitization and chemical sensitization. Following the addition of chemical sensitizers and when optimally ripened, (S-2-5) and compound (4-6) were added to stop ripening. Red-sensitive silver halide emulsions (R-1a) to (R-9a) were thus obtained.

| | |
|---|---|
| Sodium thiosulfate | 1.2 × 10⁻⁵ mol/mol AgX |
| Chloroauric acid | 1.5 × 10⁻⁵ mol/mol AgX |
| Compound S-2-5 | 1.2 × 10⁻⁴ mol/mol AgX |
| Sensitizing dye RS-1 | 1.0 × 10⁻⁴ mol/mol AgX |
| Sensitizing dye RS-2 | 1.0 × 10⁻⁴ mol/mol AgX |
| Compound (1-21) | 2.0 × 10⁻⁵ mol/mol AgX |
| Compound (4-6) | 2.0 × 10⁻⁵ mol/mol AgX |

Preparation of Red-Sensitive Emulsion (R-9b)

To the foregoing silver halide emulsion (R-9), sensitizing dyes (RS-1) and (RS-2) were added at 60° C., a pH of 5.0 and a pAg of 7.1 and subsequently, the compound (1-21), sodium thiosulfate, trifury;phosphine selenide and chloroauric acid were successively added to perform spectral sensitization and chemical sensitization. Following addition of the chemical sensitizers and when optimally ripened, compound (S-2-5) and compound (4-6) were added to stop ripening. A red-sensitive silver halide emulsion (R-9b) was thus obtained.

| | | |
|---|---|---|
| Sodium thiosulfate | 7.2 × 10⁻⁶ | mol/mol AgX |
| Trifurylphosphine selenide | 4.8 × 10⁻⁶ | mol/mol AgX |
| Chloroauric acid | 1.5 × 10⁻⁵ | mol/mol AgX |
| Compound S-2-5 | 1.2 × 10⁻⁴ | mol/mol AgX |
| Sensitizing dye RS-1 | 1.0 × 10⁻⁴ | mol/mol AgX |
| Sensitizing dye RS-2 | 1.0 × 10⁻⁴ | mol/mol AgX |
| Compound (1-21) | 2.0 × 10⁻⁵ | mol/mol AgX |
| Compound (4-6) | 2.0 × 10⁻⁵ | mol/mol AgX |

In the preparation of red-sensitive silver halide emulsions, 2.0×10⁻³ mol/mol AgX of compound SS-1 was added after completion of the preparation.

Preparation of Silver Halide Color Photographic Material

Preparation of Sample 101

There was prepared a paper support laminated, on the light-sensitive layer coating side of paper having a weight of 180 g/m², with high density polyethylene, provided that the light-sensitive layer side was laminated with polyethylene melt containing surface-treated anatase type titanium oxide in an amount of 15% by weight. This reflection support was subjected to corona discharge and provided with a gelatin sublayer, and further thereon, the following component layers, as shown below were provided to prepare a silver halide color photographic material Sample 101.

Coating solutions were prepared according to the following procedure.

1st Layer Coating Solution

To 3.34 g of yellow coupler (Y-1), 10.02 of yellow coupler (Y-2) and 1.67 g of yellow coupler (Y-3), 1,67 g of dye image stabilizer (ST-1), 1,67 g of dye image stabilizer (ST-2), 3.34 g of dye image stabilizer (ST-5), 0.167 g of antistaining agent (HQ-1), 2.67 g of image stabilizer A, 1.34 g of image stabilizer B, 5.0 g of high boiling organic solvent (DBP) and 1.67 g of high boiling solvent (DNP) was added 60 ml of ethyl acetate. Using an ultrasonic homogenizer, the resulting solution was dispersed in 320 ml of an aqueous 7% gelatin solution containing 5 ml of an aqueous 10% surfactant (SU-1) solution to obtain 500 ml of a yellow coupler emulsified dispersion. The obtained dispersion was mixed with the blue-sensitive silver halide emulsion (B-1a) to prepare a 1st layer coating solution. 2nd to 7th layer coating solution

Coating solutions for the 2nd layer to 7th layer were each prepared similarly to the 1st layer coating solution, and the respective coating solutions were coated so as to have a coating amount as shown below.

Hardeners (H-1) and (H-2) were incorporated into the 2nd, 4th and 7th layers. There were also incorporated surfactants, (SU-2) and (SU-3) as a coating aid to adjust surface tension. Further to each layer was a fungicide (F-1) so as to have a total amount of 0.04/m². The amount of silver halide contained in the respective layers was represented by equivalent converted to silver.

Additives Used in Sample 101 are as Follows:

SU-1: Sodium tri-i-propylnaphthalenesulfonate

SU-2: Di(2-ethylhexyl)sulfosuccinate sodium salt

SU-3: 2,2,3,3,4,4,5,5-Octafluoropentyl sulfosuccinate sodium salt

DBP: Dibutyl phthalate

DNP: Dinonyl phthalate

DOP: Dioctyl phthalate

DIDP: Diisodecyl phthalate

H-1: Tetrakis(vinylsulfonylmethyl)methane

H-2: 2,4-Dichloro-6-hydroxy-s-triazine sodium salt

HQ-1: 2,5-di-t-octylhydroquinone

HQ-2: 2,5-di-sec-dodecylhydroquinone

HQ-3: 2,5-di-sec-tetradecylhydroquinone

HQ-4: 2-sec-dodecyl-5-sec-tetradecyhydroquinone

HQ-5: 2,5-di[1,1-dimethyl-4-hexyloxycarbonyl)butyl]-hydroquinone

Image stabilizer A: p-t-Octylphenol

Image stabilizer B: poly(t-butylacrylamide)

| Layer | Constitution | Amount (g/m²) |
|---|---|---|
| 7th Layer | Gelatin | 0.70 |
| (Protective layer) | DIDP | 0.002 |
| | DBP | 0.002 |
| | Silicon dioxide | 0.003 |
| 6th Layer | Gelatin | 0.40 |
| (UV absorbing layer) | AI-1 | 0.01 |
| | UV absorbent (UV-1) | 0.07 |
| | UV absorbent (UV-2) | 0.12 |
| | Antistaining agent (HQ-5) | 0.02 |
| 5th Layer | Gelatin | 1.00 |
| (Red-sensitive layer) | Red-sensitive emulsion (R-1a) | 0.17 |
| | Cyan coupler (C-1) | 0.22 |
| | Cyan coupler (C-2) | 0.06 |
| | Dye image stabilizer (ST-1) | 0.06 |
| | Antistaining agent (HQ-1) | 0.003 |
| | DBP | 0.10 |
| | DOP | 0.20 |
| 4th Layer | Gelatin | 0.94 |
| (UV absorbing layer) | AI-1 | 0.02 |
| | UV absorbent (UV-1) | 0.17 |
| | UV absorbent (UV-2) | 0.27 |
| | Antistaining agent (HQ-5) | 0.06 |
| 3rd Layer | Gelatin | 1.30 |
| (Green-sensitive layer) | AI-2 | 0.01 |
| | Green-sensitive Emulsion (G-1a) | 0.12 |
| | Magenta coupler (M-1) | 0.05 |
| | Magenta coupler (M-2) | 0.15 |
| | Dye image stabilizer (ST-3) | 0.10 |
| | Dye image stabilizer (ST-4) | 0.02 |
| | DIDP | 0.10 |
| | DBP | 0.10 |
| 2nd layer | Gelatin | 1.20 |
| (Interlayer) | AI-3 | 0.01 |
| | Antistaining agent (HQ-1) | 0.02 |
| | Antistaining agent (HQ-2) | 0.03 |
| | Antistaining agent (HQ-3) | 0.06 |
| | Antistaining agent (HQ-4) | 0.03 |
| | Antistaining agent (HQ-5) | 0.03 |
| | DIDP | 0.04 |
| | DBP | 0.02 |
| 1st layer | Gelatin | 1.10 |
| (Blue-sensitive layer) | Blue-sensitive Emulsion (B-1a) | 0.24 |
| | Yellow coupler (Y-1) | 0.10 |
| | Yellow coupler (Y-2) | 0.30 |
| | Yellow coupler (Y-3) | 0.05 |
| | Dye image stabilizer (ST-1) | 0.05 |
| | Dye image stabilizer (ST-2) | 0.05 |
| | Dye image stabilizer (ST-5) | 0.10 |
| | Antistaining agent (HQ-1) | 0.005 |
| | Image stabilizer A | 0.08 |
| | Image stabilizer B | 0.04 |
| | DNP | 0.05 |
| | DBP | 0.15 |
| Support | Polyethylene-laminated paper | |
| | containing a small amount of colorant | |

Y-1

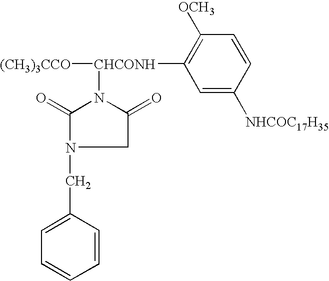

Y-2

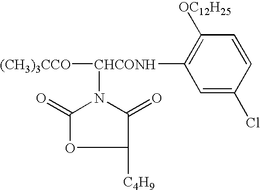

Y-3

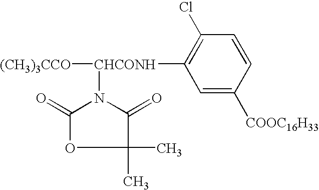

M-1

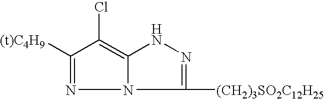

M-2

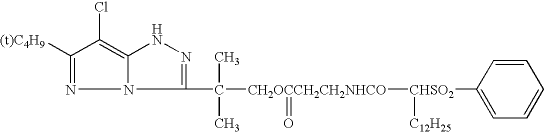

C-1

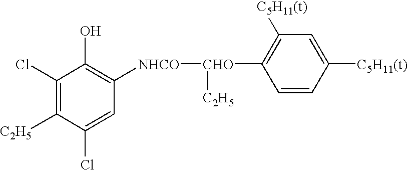

C-2

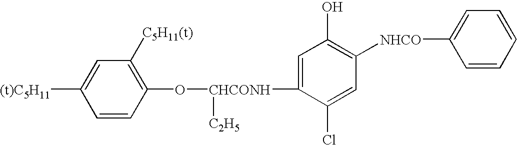

ST-1

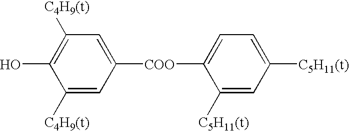

ST-2

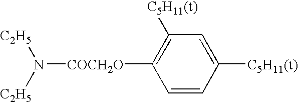

ST-3

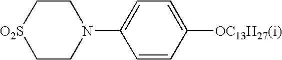

ST-4

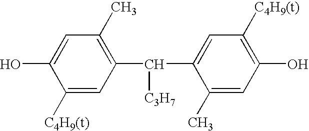

ST-5

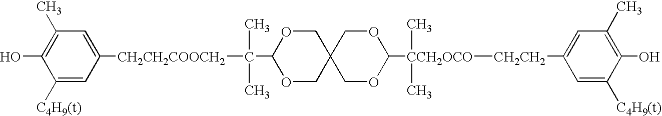

AI-1

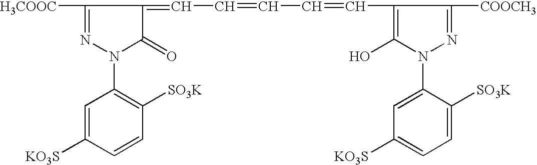

AI-2

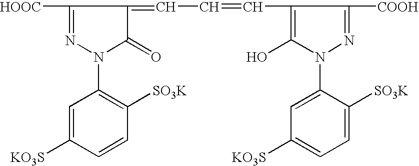

AI-3

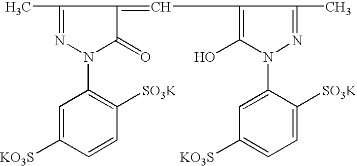

F-1

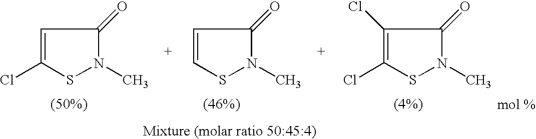

UV-1

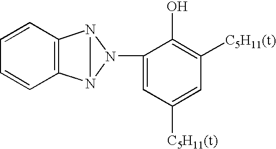

UV-2

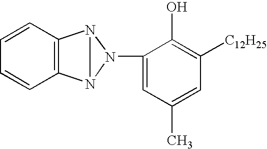

Preparation of Samples 102 to 110

Samples 102 to 110 were prepared similarly to Sample 101, except that blue-sensitive silver halide emulsion (B-1a), green-sensitive silver halide emulsion (G-1a) and red-senstitive silver halide emulsion (R-1a) were respectively replaced by silver halide emulsions shown in Table 2.

TABLE 2

| Sample | Silver Halide Emulsion | | | |
|---|---|---|---|---|
| No. | 1st Layer | 3rd Layer | 5th Layer | Remark |
| 101 | B-1a | G-1a | R-1a | Comp. |
| 102 | B-2a | G-2a | R-2a | Comp. |
| 103 | B-3a | G-3a | R-3a | Inv. |
| 104 | B-4a | G-4a | R-4a | Inv. |
| 105 | B-5a | G-5a | R-5a | Inv. |
| 106 | B-6a | G-6a | R-6a | Inv. |
| 107 | B-7a | G-7a | R-7a | Inv. |
| 108 | B-8a | G-8a | R-8a | Inv. |
| 109 | B-9a | G-9a | R-9a | Inv. |
| 110 | B-9b | G-9b | R-9b | Inv. |

The thus prepared samples 101 to 110 were each evaluated with respect to sensitivity, latent image stability and storage stability in accordance with the following procedure.

Samples were each exposed through an optical wedge to a xenon flash at 10⁻⁶ sec. using a sensitometer for use in high intensity exposure (available from YAMASHITA DENSO Co., Ltd., SX-20 Type). After being allowed to stand for 5 min., exposed samples were processed according to the following color process (which was denoted as process A). Separately samples were also exposed in the same manner as above and after 5 sec., the exposed samples were processed (which was denoted as process B). The thus processed samples were each subjected to densitometry using an optical densitometer (PDA-65 Type, available from Konica Corp.), with respect to yellow reflection image density. Characteristic curves for yellow images, comprising an ordinate (reflection density, D) and an abscissa (exposure, LogE) were prepared and the respective characteristic values were each evaluated as follows.

Sensitivity (or denoted as S) of each sample was determined according to the following equation (1) described below. Sensitivity was represented by a relative value, based on the sensitivity of sample 101 being 100. The minimum density value in the respective characteristic curves was represented as a fog density (or denoted simply as fog) by a relative value, based on the fog density of sample 101 being 100. Further, contrast in process A (denoted as γa) and contrast in process B (denoted as γb) were calculated according to the following equation (2) and variation Δγ was determined according to the following equation (3):
Sensitivity (S)=1/(exposure amount giving a density of fog plus 1.0) (1)
Contrast (γ)=1/[log(exposure amount giving a density of fog plus 0.8)−Log(exposure amount giving a density of fog plus 1.8)] (2)
Δγ=(γb/γa)×100 (3)

A value of Δγ closer to 100 indicates superior latent image stability.

Storage stability was evaluated in the following manner. After aged at 55° C. and 40% RH for 6 days, samples were processed similarly and fog densities of the respective samples were represented by a relative value, based on the fog density of sample 101 which was processed in process A immediately after preparation being 100.

Color Process

| Processsing step | Temperature | | Time | Repl. Amt.* |
|---|---|---|---|---|
| Color developing | 38.0 ± 0.3° | C. | 45 sec. | 80 ml |
| Bleach-fixing | 35.0 ± 0.5° | C. | 45 sec. | 120 ml |
| Stabilizing | 30-34° | C. | 60 sec. | 150 ml |
| Drying | 60-80° | C. | 30 sec. | |

*Replenishing amount

Color Developer (Tank Solution, Replenisher)

| | Tank soln. | | Replenisher | |
|---|---|---|---|---|
| Water | 800 | ml | 800 | ml |
| Triethylenediamine | 2 | g | 3 | g |
| Diethylene glycol | 10 | g | 10 | g |
| Potassium bromide | 0.01 | g | — | |
| Potassium chloride | 3.5 | g | — | |
| Potassium sulfite | 0.25 | g | 0.5 | g |
| N-ethyl-N(β-methanesulfonamidoethyl)- | 6.0 | g | 10.0 | g |
| 3-methyl-4-aminoaniline sulfate | | | | |
| N,N-diethylhydroxyamine | 6.8 | g | 6.0 | g |
| Triethanolamine | 10.0 | g | 10.0 | g |
| Sodium diethyltriaminepentaacetate | 2.0 | g | 2.0 | g |
| Brightener (4,4′-diaminostilbene- | 2.0 | g | 2.5 | g |
| disulfonate derivative) | | | | |
| Potassium carbonate | 30 | g | 30 | g |

Water is added to make 1 liter, and the pH of the tank solution and replenisher were respectively adjusted to 10.10 and 10.60 with sulfuric acid or potassium hydroxide.

Bleach-Fixer (Tank Solution, Replenisher)

| | | |
|---|---|---|
| Ammonium ferric diethyltriaminepentaacetate | 65 | g |
| dihydrate | | |
| diethyltriaminepentaacetic acid | 3 | g |
| Ammonium thiosulfate (70% aqueous solution) | 100 | ml |
| 2-Amino-5-mercapto-1,3,4-thiadiazole | 2.0 | g |
| Ammonium sulfite (40% aqueous solution) | 27.5 | ml |

Water is added to make 1 liter, and the pH is adjusted to 5.0.

Stabilizer (Tank Solution, Replenisher)

| | |
|---|---|
| o-Phenylphenol | 1.0 g |
| 5-Chloro-2-methyl-4-isothiazoline-3-one | 0.02 g |
| 2-Methyl-4-isothiazoline-3-one | 0.02 g |
| Diethylene glycol | 1.0 g |
| Brightener (Chinopal SFP) | 2.0 g |
| 1-Hydroxyethylidene-1,1-diphosphonic acid | 1.8 g |
| Bismuth chloride (40% aqueous solution) | 0.65 g |
| Magnesium sulfate heptahydrate | 0.2 g |
| Polyvinyl pyrrolidine (PVP) | 1.0 g |
| Ammonia water (25% aqueous | 2.5 g |
| ammonium hydroxide solution) | |
| Trisodium nitrilotriacetate | 1.5 g |

Water is added to make 1 liter, and the pH is adjusted to 7.5 with sulfuric acid or potassium hydroxide.

The thus obtained results are shown in Table 3.

TABLE 3

| | | Latent | | |
|---|---|---|---|---|
| Sample | | Image | Storage | |
| No. | S | Stability | Stability | Remark |
| 101 | 100 | 70 | 127 | Comp. |
| 102 | 103 | 73 | 129 | Comp. |
| 103 | 114 | 84 | 118 | Inv. |
| 104 | 118 | 87 | 118 | Inv. |
| 105 | 120 | 89 | 115 | Inv. |
| 106 | 122 | 89 | 114 | Inv. |
| 107 | 125 | 92 | 112 | Inv. |
| 108 | 127 | 94 | 108 | Inv. |
| 109 | 136 | 96 | 108 | Inv. |
| 110 | 138 | 96 | 106 | Inv. |

As is apparent from Table 3, it was proved that samples using the silver halide emulsion relating to this invention resulted in enhanced sensitivity, superior latent image stability and improved storage stability, as compared to comparative examples. Further, green-sensitive and red-sensitive silver halide emulsions were similarly evaluated and it was also proved that similarly to the blue-sensitive emulsions, samples using silver halide emulsions relating to this invention led to superior results. Specifically, silver halide emulsions exhibiting a coefficient of variation in iodide content among grains of less than 30% resulted in further enhanced sensitivity and superior latent image stability. When the bromide content of silver halide grains was within the range of 1.5 to 6.0 mol %, the coefficient of variation in bromide content among grains was less than 30% or silver halide grains included at least an 8 group metal complex containing an aqua ligand and/or an organic ligand, further enhanced sensitivity and superior latent image stability and storage stability were achieved. When the iodide content of silver halide grains was within the range of 0.05 to 2.0 mol % or silver halide grains were subjected to selenium sensitization, further superior results were achieved with respect to sensitivity and storage stability.

### Example 2

Using photographic materials prepared in Example 1, 127 mm wide roll form samples were prepared and evaluated with respect to suitability for digital exposure.

Thus, negative images of processed negative film (Konica Color New CENTURIA 400) were digitized using a film scanner, Q scan 1202JW (available from Konica Corp.) so as to be treatable using computer software, photoshop (Ver. 5.5, available from Adobe Co.). Further to the thus treated images, letters of various sizes and fine lines were added to form image data and operated so as to perform exposure using the following digital scanning exposure apparatus.

As light sources were used a 473 nm laser which was obtained by subjecting YAG solid laser (oscillation wavelength: 946 nm) using semiconductor laser GaAlAs (oscillation wavelength: 808.5 nm) as an exciting light to wavelength conversion by a SHG crystal of KNbO₃; a 532 nm laser which was obtained by subjecting YVO₄ solid laser (oscillation wavelength: 1064 nm) using semiconductor laser GaAlAs (oscillation wavelength: 808.7 nm) as an exciting light to wavelength conversion by a SHG crystal of KTP; and AlGaInP laser (oscillation wavelength: 670 nm). There was prepared an apparatus, in which three color laser lights were each moved in the direction vertical to the scanning direction, using a polygon mirror so that scanning exposure was successively performed onto color print paper. The exposure amount was controlled by electrical adjustment of the light quantity of the semiconductor lasers. Scanning exposure was conducted at 400 dpi (dpi represents the number of dots per inch or 2.54 cm) and the exposure time per picture element (or pixel) was 5×10⁻⁸ sec. The exposure amount was adjusted so that the best print images were obtained in the respective samples. After performing scanning exposure, cabinet-size print images were obtained in accordance with the following process.

Color Process

| Processsing step | Temperature | | Time | Repl. Amt.* |
|---|---|---|---|---|
| Color developing | 38.0 ± 0.3° | C. | 22 sec. | 81 ml |
| Bleach-fixing | 35.0 ± 0.5° | C. | 22 sec. | 54 ml |
| Stabilizing | 30-34° | C. | 25 sec. | 150 ml |
| Drying | 60-80° | C. | 30 sec. | |

*Replenishing amount

Color Developer (Tank Solution, Replenisher)

| | Tank soln. | | Replenisher | |
|---|---|---|---|---|
| Water | 800 | ml | 800 | ml |
| Diethylene glycol | 10 | g | 10 | g |
| Potassium bromide | 0.01 | g | — | |
| Potassium chloride | 3.5 | g | — | |
| Potassium sulfite | 0.25 | g | 0.5 | g |
| N-ethyl-N(β-methanesulfonamidoethyl)- | 6.0 | g | 10.5 | g |
| 3-methyl-4-aminoaniline sulfate | | | | |
| N,N-diethylhydroxyamine | 3.5 | g | 6.0 | g |
| N,N-bis(2-sulfoethyl)hydroxylamine | 3.5 | g | 6.0 | g |
| Triethanolamine | 10.0 | g | 10.0 | g |
| Sodium diethyltriaminepentaacetate | 2.0 | g | 2.0 | g |
| Brightener (4,4′-diaminostilbene- | 2.0 | g | 2.5 | g |
| disulfonate derivative) | | | | |
| Potassium carbonate | 30 | g | 30 | g |

Water is added to make 1 liter, and the pH of the tank solution and replenisher were respectively adjusted to 10.1 and 10.6 with sulfuric acid or potassium hydroxide.

Bleach-Fixer (Tank Solution, Replenisher)

| | Tank soln. | | Replenisher | |
|---|---|---|---|---|
| Ammonium ferric diethyltriaminepentaacetate | 100 | g | 50 | g |
| dihydrate | | | | |
| diethyltriaminepentaacetic acid | 3 | g | 3 | g |
| Ammonium thiosulfate (70% aqueous solution) | 200 | ml | 100 | ml |
| 2-Amino-5-mercapto-1,3,4-thiadiazole | 2.0 | g | 1.0 | g |
| Ammonium sulfite (40% aqueous solution) | 50 | ml | 25 | ml |

Water is added to make 1 liter, and the pH is adjusted to 7.0 with potassium carbonate or glacial acetic acid.

Stabilizer (Tank Solution, Replenisher)

| | | |
|---|---|---|
| o-Phenylphenol | 1.0 | g |
| 5-Chloro-2-methyl-4-isothiazoline-3-one | 0.02 | g |
| 2-Methyl-4-isothiazoline-3-one | 0.02 | g |
| Diethylene glycol | 1.0 | g |
| Brightener (Chinopal SFP) | 2.0 | g |
| 1-Hydroxyethylidene-1,1-diphosphonic acid | 1.8 | g |
| PVP | 1.0 | g |
| Ammonia water (25% aqueous | 2.5 | g |
| ammonium hydroxide solution) | | |
| Ethylenediaminetetraacetic acid | 1.0 | g |
| Ammonium sulfite (40% aqueous solution) | 10 | ml |

Water is added to make 1 liter, and the pH is adjusted to 7.5 with sulfuric acid or potassium hydroxide.

The thus obtained print images were visually evaluated by 20 observers with respect to clearness of fine lines and letters, human skin tone reproduction and color reproduction of green foliage. Further, 100 sheets were exposed for each sample and successively processed. The first and 100th prints were evaluated with respect to print reproducibility, based on the following criteria.

(1) Clearness of Fine Line and Letter

A: neutral fine lines and letters were clearly distinguishable

B: neutral fine lines and letters were clearly distinguishable but outlines becoming slightly blurred

C: neutral fine lines and letters were clearly distinguishable but blurred

D: neutral fine lines and letters were blurred and undistinguishable.

(2) Human Skin Tone Reproduction

A: bright and natural reproduction;

B: natural reproduction;

C: being slightly muted;

D: being muted.

(3) Color Reproduction of Green Foliage

A: bright and clear reproduction

B: clear reproduction

C: slightly muted reproduction;

D: definitely muted reproduction

(4) Print Reproducibility

A: no difference in prints ere noticed;

B: slight difference in prints were noticed but treated as the same;

C: some differences in prints were noticed and weighed;

D: clear differences in prints were noticed and unacceptable in practice

Evaluation results are shown in Table 4.

TABLE 4

| | Clearness | | | | |
|---|---|---|---|---|---|
| | of Fine | Skin Tone | Reproduction | Print | |
| Sample | Line and | Repro- | of Leaves | Repro- | |
| No. | Letter | duction | Green | ducibility | Remark |
| 101 | D | D | D | D | Comp. |
| 102 | D | D | D | C | Comp. |
| 103 | B | B | C | B | Inv. |
| 104 | B | B | B | B | Inv. |
| 105 | B | B | A | A | Inv. |
| 106 | A | B | A | A | Inv. |
| 107 | A | B | A | A | Inv. |
| 108 | A | B | A | A | Inv. |
| 109 | A | B | A | A | Inv. |
| 110 | A | B | A | A | Inv. |

As is apparent from Table 4, it was proved that samples relating to this invention exhibited superior performance with respect to clearness of fine lines and letters, human skin tone reproduction, color reproduction of green foliage and print reproducibility. Specifically, when the coefficient of variation in iodide content among grains, or the bromide content and the iodide content of silver halide grains fell within the preferred region, further superior performance was achieved.

### Example 3

From negative images of processed negative film (Konica Color New CENTURIA 400), positive images of processed reversal film (Konica Chrome SINBI 1200 High Quality) and photographing image data taken by a digital camera Digital Revio KD-200Z (available from Konica Corp.), print images were obtained in accordance with the following procedure.

There were prepared roll form samples of 127 mm width, using photographic materials prepared in Example 1. The samples were exposed and processed in Konica digital minilab system QD-21 SUPER (in which print processor QDP-1500 SUPER and processing chemicals ECOJET-HQA-P were employed and processing is conducted in accordance with process CPK-HQA-P). The obtained print samples were evaluated similarly to Example 2. Results thereof are shown in Table 5. Similarly in Example 2, it was proved that samples relating to this invention achieved superior effects. Specifically, when the bromide content and the iodide content of silver halide grains fell within the preferred region, further superior performance was achieved.

TABLE 5

| | Clearness | | Repro- | | |
|---|---|---|---|---|---|
| | of Fine | Skin Tone | duction | | |
| Sample | Line and | Repro- | of Leaves | Print | |
| No. | Letter | duction | Green | Reproducibility | Remark |
| 101 | D | D | D | D | Comp. |
| 102 | D | D | D | C | Comp. |
| 103 | B | B | B | B | Inv. |
| 104 | B | B | B | B | Inv. |
| 105 | B | B | A | A | Inv. |
| 106 | A | B | A | A | Inv. |
| 107 | A | B | A | A | Inv. |
| 108 | A | B | A | A | Inv. |
| 109 | A | B | A | A | Inv. |
| 110 | A | B | A | A | Inv. |

### Example 4

Preparation of Silver Halide Emulsion (B-11)

To 1 liter of an aqueous 2% solution of deionized ossein gelatin (containing 10 ppm calcium), maintained at 40° C. were simultaneously added solutions (A11) and (B11) for 20 min, while controlling the pAg and pH at 7.3 and 3.0, respectively. Subsequently, solutions (A12) and (B12) were added for 90 min with controlling the pAg and pH at 8.0 and 5.5, respectively, provided that when 50% of solution (B12) was added, solution solution (D11) was added and the remained solutions (A12) and (B12) were subsequently added. Then, solutions (A13) and (B13) were added over 15 min. with controlling the pAg and pH at 8.0 and 5.5, respectively. The pAg was controlled in accordance with the method described in JP-A No. 59-45437 and the pH was controlled using aqueous sulfuric acid or sodium hydroxide solution.

| Solution (A11) | | |
|---|---|---|
| Sodium chloride | 3.43 | g |
| Water to make | 200 | ml |
| Solution (A12) | | |
| Sodium chloride | 72.3 | g |
| K₂[IrCl₆] | 3.5 × 10⁻⁸ | mol/mol AgX |
| K₂[IrBr₆] | 1.0 × 10⁻⁸ | mol/mol AgX |
| K₄[Fe(CN)₆] | 2.5 × 10⁻⁵ | mol/mol AgX |
| Water to make | 420 | ml |
| Solution (A13) | | |
| Sodium chloride | 30.9 | g |
| Water to make | 180 | ml |
| Solution (B11) | | |
| Silver nitrate | 10 | g |
| Water to make | 200 | ml |
| Solution (B12) | | |
| Silver nitrate | 210 | g |
| Water to make | 420 | ml |
| Solution (B13) | | |
| Silver nitrate | 90 | g |
| Water to make | 180 | ml |
| Solution (D11) | | |
| Potassium bromide | 2.61 | g |
| Water to make | 11.0 | ml |

After completing addition, an aqueous 5% solution containing 30 g of chemically-modified gelatin (modification rate of 95%), in which an amino group of gelatin was phenylcarbamoylated, was added to perform desalting in accordance with the method described in JP-A No. 5-72658, and an aqueous gelatin solution was further added thereto to obtain silver halide emulsion (B-11) comprising monodisperse cubic grains having an average grain size (equivalent cubic edge length) of 0.50 μm.

Preparation of Silver Halide Emulsion (B-12)

Similarly to the foregoing silver halide emulsion (B-11), silver halide emulsion (B-12) comprising monodisperse cubic grains having an average grain size (equivalent cubic edge length) of 0.50 μm was prepared, except that after addition of the solution (B12), the following solution (C11) was added:

Solution (C11)

| | | |
|---|---|---|
| Potassium iodide | 0.12 | g |
| Water to make | 5.0 | ml |

Preparation of Silver Halide Emulsion (B-13)

Similarly to the foregoing silver halide emulsion (B-11), silver halide emulsion (B-13) comprising monodisperse cubic grains having an average grain size (equivalent cubic edge length) of 0.50 μm, except that the solution (D11) was not added, the following solution (C12) was added after 30% of the solution (B12) and the following solution (D12) was added after 30% of the solution (B13) was added:

| Solution (C12) | | |
|---|---|---|
| Potassium iodide | 0.12 | g |
| Water to make | 50.0 | ml |
| Solution (D12) | | |
| Potassium bromide | 2.61 | g |
| Water to make | 110.0 | ml |

Preparation of Silver Halide Emulsion (B-14)

Similarly to the foregoing silver halide emulsion (B-13), silver halide emulsion (B-14) comprising monodisperse cubic grains having an average grain size (equivalent cubic edge length) of 0.50 μm was prepared, except that the solution (D12) was replaced by the following solution (D13):

Solution (D13)

| | | |
|---|---|---|
| Potassium bromide | 5.44 | g |
| Water to make | 230.0 | ml |

Preparation of Silver Halide Emulsion (B-15)

Similarly to the foregoing silver halide emulsion (B-14), silver halide emulsion (B-15) comprising monodisperse cubic grains having an average grain size (equivalent cubic edge length) of 0.50 μm was prepared, except that the solution (C12) was replaced by the following solution (C13):

Solution (C13)

| | | |
|---|---|---|
| Potassium iodide | 0.30 | g |
| Water to make | 100.0 | ml |

Preparation of Silver Halide Emulsion (B-16)

Similarly to the foregoing silver halide emulsion (B-15), silver halide emulsion (B-16) comprising monodisperse cubic grains having an average grain size (equivalent cubic edge length) of 0.50 μm was prepared, except that the solution (D13) was replaced by the following solution (E11), then, the pH was adjusted to 9.0 and after 3 min., the pH was again adjusted 5.5 and the addition of the solutions (A13) and (B13) was conducted.

Solution (E11)

| | | |
|---|---|---|
| Bromide ion releasing compound 130 | 4.6 × 10⁻² | mol |
| Water to make | 100.0 | ml |
| Bromide ion releasing compound 130 | | |
| 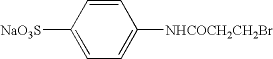 | | |

Preparation of Silver Halide Emulsion (B-17)

Similarly to the foregoing silver halide emulsion (B-15), silver halide emulsion (B-17) comprising monodisperse cubic grains having an average grain size (equivalent cubic edge length) of 0.50 μm was prepared, except that the solution (D13) was replaced by the following solution (E12), then, the pH was adjusted to 9.0 and after 3 min., the pH was again adjusted 5.5 and the addition of the solutions (A13) and (B13) was conducted.

Solution (E12)

| | | |
|---|---|---|
| Bromide ion releasing compound 100 | 6.5 × 10⁻² | mol |
| Water to make | 150.0 | ml |
| Bromide ion releasing compound 100 | | |
| 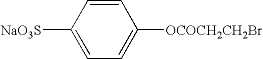 | | |

Preparation of Silver Halide Emulsion (B-18)

Similarly to the foregoing silver halide emulsion (B-17), silver halide emulsion (B-18) comprising monodisperse cubic grains having an average grain size (equivalent cubic edge length) of 0.50 μm was prepared, except that the solution (A12) was replaced by the following solution (A14):

Solution (A14)

| | | |
|---|---|---|
| Sodium chloride | 72.3 | g |
| K₂[IrCl₆] | 8.0 × 10⁻⁹ | mol/mol AgX |
| K₂[IrBr₆] | 5.0 × 10⁻⁹ | mol/mol AgX |
| K₂[IrCl₅(H₂O)] | 9.0 × 10⁻⁸ | mol/mol AgX |
| K₂[IrCl₅(thiazole)] | 6.0 × 10⁻⁹ | mol/mol AgX |
| K₄[Fe(CN)₆] | 2.5 × 10⁻⁵ | mol/mol AgX |
| Water to make | 420 | ml |

Preparation of Silver Halide Emulsion (B-19)

Similarly to the foregoing silver halide emulsion (B-17), silver halide emulsion (B-19) comprising monodisperse cubic grains having an average grain size (equivalent cubic edge length) of 0.50 μm was prepared, except that the solution (A12) was replaced by the following solution (A15):

Solution (A15)

| | | |
|---|---|---|
| Sodium chloride | 72.3 | g |
| K₂[IrCl₆] | 7.0 × 10⁻⁹ | mol/mol AgX |
| K₂[IrBr₆] | 5.0 × 10⁻⁹ | mol/mol AgX |
| K₂[IrCl₅(H₂O)] | 1.2 × 10⁻⁷ | mol/mol AgX |
| K₂[IrBr₅(H₂O)] | 9.0 × 10⁻⁹ | mol/mol AgX |
| K₂[IrCl₅(thiazole)] | 3.0 × 10⁻⁹ | mol/mol AgX |
| K₄[Ru(CN)₆] | 2.5 × 10⁻⁵ | mol/mol AgX |
| Water to make | 420 | ml |

Preparation of Silver Halide Emulsions (G-11) to (G-19)

Silver halide emulsions (G-11) to (G-19) were prepared similarly to the foregoing silver halide emulsions (B-11) to (B-19), respectively, except that the addition time of solutions (A11), (A12), (A13), (A14), (A15), (B11), (B12) and (B13) was varied. The obtained silver halide emulsions (G-11) to (G-19) were each comprised of monodisperse cubic grains having an average grain size (equivalent cubic edge length) of 0.35 μm.

Preparation of Silver Halide Emulsions (R-11) to (R-19)

Silver halide emulsions (R-11) to (R-19) were prepared similarly to the foregoing silver halide emulsions (B-11) to (B-19), respectively, except that the addition time of solutions (A11), (A12), (A13), (A14), (A15), (B11), (B12) and (B3) was varied. The obtained silver halide emulsions (R-11) to (R-19) were each comprised of monodisperse cubic grains having an average grain size (equivalent cubic edge length) of 0.30 μm.

Characteristics of silver halide emulsions (B-11) to (B-19), (G-11) to (G-19) and (R-11) to (R-19) are shown in Table 6. It was proved that in each of the foregoing emulsions, the average aspect ratio of the silver halide grains was less than 1.3 and more than 50% by number of the silver halide grains was accounted for by grains having a chloride content of not less than 90 mol %, an iodide content of from 0 to 2 mol %, a bromide content of from 0.1 to 10 mol %.

TABLE 6

| | Average | | Average | Average | Average | | Surface | | |
|---|---|---|---|---|---|---|---|---|---|
| | Grain | | Chloride | Bromide | Iodide | Average | Bromide | | |
| | Size | CV-1*¹ | Content | Content | Content | Aspect | Content | CV-3*² | |
| Emulsion | (μm) | (%) | (mol %) | (mol %) | (mol %) | Ratio | (mol %) | (%) | Remark |
| B-11 | 0.50 | 0.07 | 98.8 | 1.2 | 0 | 1.13 | 0.2 | 33 | Comp. |
| B-12 | 0.50 | 0.07 | 98.76 | 1.2 | 0.04 | 1.13 | 0.2 | 35 | Comp. |
| B-13 | 0.50 | 0.07 | 98.76 | 1.2 | 0.04 | 1.13 | 2.0 | 35 | Inv. |
| B-14 | 0.50 | 0.07 | 97.46 | 2.5 | 0.04 | 1.13 | 5.0 | 34 | Inv. |
| B-15 | 0.50 | 0.07 | 97.4 | 2.5 | 0.1 | 1.13 | 5.0 | 33 | Inv. |
| B-16 | 0.50 | 0.07 | 97.4 | 2.5 | 0.1 | 1.13 | 4.0 | 35 | Inv. |
| B-17 | 0.50 | 0.07 | 96.4 | 3.5 | 0.1 | 1.13 | 5.0 | 18 | Inv. |
| B-18 | 0.50 | 0.07 | 96.4 | 3.5 | 0.1 | 1.13 | 5.0 | 18 | Inv. |
| B-19 | 0.50 | 0.07 | 96.4 | 3.5 | 0.1 | 1.13 | 5.0 | 18 | Inv. |
| G-11 | 0.35 | 0.07 | 98.8 | 1.2 | 0 | 1.13 | 0.2 | 35 | Comp. |
| G-12 | 0.35 | 0.07 | 98.76 | 1.2 | 0.04 | 1.13 | 0.2 | 36 | Comp. |
| G-13 | 0.35 | 0.07 | 98.76 | 1.2 | 0.04 | 1.13 | 2.3 | 35 | Inv. |
| G-14 | 0.35 | 0.07 | 97.46 | 2.5 | 0.04 | 1.13 | 5.3 | 35 | Inv. |
| G-15 | 0.35 | 0.07 | 97.4 | 2.5 | 0.1 | 1.13 | 5.3 | 34 | Inv. |
| G-16 | 0.35 | 0.07 | 97.4 | 2.5 | 0.1 | 1.13 | 4.4 | 32 | Inv. |
| G-17 | 0.35 | 0.07 | 96.4 | 3.5 | 0.1 | 1.13 | 5.2 | 18 | Inv. |
| G-18 | 0.35 | 0.07 | 96.4 | 3.5 | 0.1 | 1.13 | 5.2 | 18 | Inv. |
| G-19 | 0.35 | 0.07 | 96.4 | 3.5 | 0.1 | 1.13 | 5.3 | 18 | Inv. |
| R-11 | 0.30 | 0.08 | 98.8 | 1.2 | 0 | 1.13 | 0.2 | 36 | Comp. |
| R-12 | 0.30 | 0.08 | 98.76 | 1.2 | 0.04 | 1.13 | 0.2 | 37 | Comp. |
| R-13 | 0.30 | 0.08 | 98.76 | 1.2 | 0.04 | 1.13 | 2.4 | 36 | Inv. |
| R-14 | 0.30 | 0.08 | 97.46 | 2.5 | 0.04 | 1.13 | 5.5 | 35 | Inv. |
| R-15 | 0.30 | 0.08 | 97.4 | 2.5 | 0.1 | 1.13 | 5.5 | 33 | Inv. |
| R-16 | 0.30 | 0.08 | 97.4 | 2.5 | 0.1 | 1.13 | 4.2 | 33 | Inv. |
| R-17 | 0.30 | 0.08 | 96.4 | 3.5 | 0.1 | 1.13 | 5.0 | 19 | Inv. |
| R-18 | 0.30 | 0.08 | 96.4 | 3.5 | 0.1 | 1.13 | 5.0 | 19 | Inv. |
| R-19 | 0.30 | 0.08 | 96.4 | 3.5 | 0.1 | 1.13 | 5.0 | 19 | Inv. |

*¹coefficient of variation in grain size among grains
*²coefficient of variation in bromide content among grains

Preparation of Blue-Sensitive Emulsion

Similarly to silver halide emulsions (B-1a) to (B-9a) of Example 1, silver halide emulsions (B-11) to (B-19) were subjected to chemical and spectral sensitization to obtain blue-sensitive silver halide emulsions (B-11a) to (B-19a).

Similarly to silver halide emulsion (B-9b) of Example 1, silver halide emulsion (B-19) was subjected to chemical and spectral sensitization to obtain blue-sensitive silver halide emulsion (B-19b).

Preparation of Green-Sensitive Emulsion

Similarly to silver halide emulsions (G-1a) to (G-9a) of Example 1, silver halide emulsions (G-11) to (G-19) were subjected to chemical and spectral sensitization to obtain green-sensitive silver halide emulsions (G-11a) to (G-19a).

Similarly to silver halide emulsion (G-9b) of Example 1, silver halide emulsion (G-19) was subjected to chemical and spectral sensitization to obtain green-sensitive silver halide emulsion (G-19b).

Preparation of Red-Sensitive Emulsion

Similarly to silver halide emulsions (R-1a) to (R-9a) of Example 1, silver halide emulsions (R-11) to (R-19) were subjected to chemical and spectral sensitization to obtain red-sensitive silver halide emulsions (R-11a) to (R-19a).

Similarly to silver halide emulsion (R-9b) of Example 1, silver halide emulsion (R-19) was subjected to chemical and spectral sensitization to obtain blue-sensitive silver halide emulsion (R-19b). p Similarly to sample 101 of Example 1, samples 201 to 210 were prepared, provided that silver halide emulsion (B-1a) of the 1st layer, silver halide emulsion (G-1a) of the 3rd layer and silver halide emulsion (R-1a) of the 5th layer were respectively replaced, as shown in Table 7. The thus prepared samples were similarly evaluated. Results are shown in Table 8.

TABLE 7

| Sample | Silver Halide Emulsion | | | |
|---|---|---|---|---|
| No. | 1st Layer | 3rd Layer | 5th Layer | Remark |
| 201 | B-11a | G-11a | R-11a | Comp. |
| 202 | B-12a | G-12a | R-12a | Comp. |
| 203 | B-13a | G-13a | R-13a | Inv. |
| 204 | B-14a | G-14a | R-14a | Inv. |
| 205 | B-15a | G-15a | R-15a | Inv. |
| 206 | B-16a | G-16a | R-16a | Inv. |
| 207 | B-17a | G-17a | R-17a | Inv. |
| 208 | B-18a | G-18a | R-18a | Inv. |
| 209 | B-19a | G-19a | R-19a | Inv. |
| 210 | B-19b | G-19b | R-19b | Inv. |

TABLE 8

| | | Latent | | |
|---|---|---|---|---|
| Sample | | Image | Storage | |
| No. | S | Stability | Stability | Remark |
| 201 | 100 | 70 | 131 | Comp. |
| 202 | 101 | 69 | 129 | Comp. |
| 203 | 112 | 84 | 119 | Inv. |
| 204 | 115 | 87 | 116 | Inv. |
| 205 | 118 | 90 | 114 | Inv. |
| 206 | 122 | 90 | 112 | Inv. |
| 207 | 125 | 92 | 112 | Inv. |
| 208 | 127 | 94 | 107 | Inv. |
| 209 | 133 | 95 | 104 | Inv. |
| 210 | 135 | 96 | 104 | Inv. |

As is apparent from Table 8, it was proved that samples using the silver halide emulsion relating to this invention resulted in enhanced sensitivity, superior latent image stability and improved storage stability, as compared to comparative samples. When the surface iodide content of silver halide grains was from 2.5 to 10 mol %, the bromide content was from 1.5 to 6.0 mol %, the iodide content was from 0.05 to 2.0 mol %, or silver halide grains included at least an 8 group metal complex containing an aqua ligand and/or an organic ligand, further enhanced sensitivity and superior latent image stability and storage stability were achieved. When the coefficient of variation in bromide content among grains was less than 30% or silver halide grains were subjected to selenium sensitization, further superior results were achieved with respect to sensitivity and storage stability.

### Example 5

Samples 201 to 210 of Example 4 are evaluated similarly to Example 2. Results are shown in Table 9. Inventive samples achieved superior effects, as compared to comparative samples. When the iodide content of silver halide grains was within the preferred range of this invention, further superior performance was achieved.

TABLE 9

| | Clearness | | Repro- | | |
|---|---|---|---|---|---|
| | of Fine | Skin Tone | duction | | |
| Sample | Line and | Repro- | of Leaves | Print | |
| No. | Letter | duction | Green | Reproducibility | Remark |
| 201 | D | D | D | D | Comp. |
| 202 | D | D | D | C | Comp. |
| 203 | B | B | B | B | Inv. |
| 204 | B | B | B | B | Inv. |
| 205 | A | B | A | A | Inv. |
| 206 | A | B | A | A | Inv. |
| 207 | A | B | A | A | Inv. |
| 208 | A | B | A | A | Inv. |
| 209 | A | B | A | A | Inv. |
| 210 | A | B | A | A | Inv. |

### Example 6

Samples 201 to 210 of Example 4 ere evaluated similarly to Example 3. Results are shown in Table 10. Inventive sample achieved superior effects, as compared to comparative samples. When the iodide content of silver halide grains was within the preferred range of this invention, further superior performance was achieved.

TABLE 10

| | Clearness | | Repro | | |
|---|---|---|---|---|---|
| | of Fine | Skin Tone | duction | | |
| Sample | Line and | Repro- | of Leaves | Print | |
| No. | Letter | duction | Green | reproducibility | Remark |
| 201 | D | D | D | D | Comp. |
| 202 | D | D | D | C | Comp. |
| 203 | B | B | B | B | Inv. |
| 204 | B | B | B | B | Inv. |
| 205 | A | B | B | A | Inv. |
| 206 | A | B | A | A | Inv. |
| 207 | A | B | A | A | Inv. |
| 208 | A | B | A | A | Inv. |
| 209 | A | B | A | A | Inv. |
| 210 | A | B | A | A | Inv. |

### Example 7

Preparation of Silver Halide Emulsion (B-21)

To 1 liter of an aqueous 2% solution of deionized ossein gelatin (containing 10 ppm calcium), maintained at 40° C. were solutions (A21) and (B21) for 20 min, while controlling the pAg and pH at 7.3 and 3.0, respectively. Subsequently, solutions (A22) and (B22) were added for 90 min with controlling the pAg and pH at 8.0 and 5.5, respectively. Then, solutions (A23) and (B23) were added over 15 min. with controlling the pAg and pH at 8.0 and 5.5, respectively, provided that when 30% of solution (B23) was added, solution (D21) was added and when 70% of solution (B23) was added, solution (C21) was added. The pAg was controlled in accordance with the method described in JP-A No. 59-45437 and the pH was controlled using aqueous sulfuric acid or sodium hydroxide solution.

| Solution (A21) | | |
|---|---|---|
| Sodium chloride | 3.43 | g |
| Water to make | 200 | ml |
| Solution (A22) | | |
| Sodium chloride | 72.3 | g |
| K₂[IrCl₆] | 3.0 × 10⁻⁸ | mol/mol AgX |
| K₂[IrBr₆] | 1.0 × 10⁻⁸ | mol/mol AgX |
| K₄[Fe(CN)₆] | 2.0 × 10⁻⁵ | mol/mol AgX |
| Water to make | 420 | ml |
| Solution (A23) | | |
| Sodium chloride | 30.9 | g |
| Water to make | 180 | ml |
| Solution (B21) | | |
| Silver nitrate | 10 | g |
| Water to make | 200 | ml |
| Solution (B22) | | |
| Silver nitrate | 210 | g |
| Water to make | 420 | ml |
| Solution (B23) | | |
| Silver nitrate | 90 | g |
| Water to make | 180 | ml |
| Solution (C21) | | |
| Potassium iodide | 0.12 | g |
| Water to make | 5.0 | ml |
| Solution (D21) | | |
| Potassium bromide | 1.09 | g |
| Water to make | 11.0 | ml |

After completing addition, an aqueous 5% solution containing 30 g of chemically-modified gelatin (modification rate of 95%), in which an amino group of gelatin was phenylcarbamoylated, was added to perform desalting in accordance with the method described in JP-A No. 5-72658, and an aqueous gelatin solution was further added thereto to obtain silver halide emulsion (B-21) comprising monodisperse cubic grains having an average grain size (equivalent cubic edge length) of 0.50 μm.

Preparation of Silver Halide Emulsion (B-22)

Similarly to the foregoing silver halide emulsion (B-21), silver halide emulsion (B-22) comprising monodisperse cubic grains having an average grain size (equivalent cubic edge length) of 0.50 μm was prepared, except that the solution (D21) was replaced by the following solution (D22):

Solution (D22)

| | | |
|---|---|---|
| Potassium bromide | 2.61 | g |
| Water to make | 11.0 | ml |

Preparation of Silver Halide Emulsion (B-23)

Similarly to the foregoing silver halide emulsion (B-22), silver halide emulsion (B-23) comprising monodisperse cubic grains having an average grain size (equivalent cubic edge length) of 0.50 μm was prepared, except that the solution (C21) was replaced by the following solution (E21), then, the pH was adjusted to 9.0 and after 3 min., the pH was again adjusted 5.5 and the addition of the solutions (A21) and (B21) was conducted.

Solution (E21)

| Iodide ion releasing compound 21 | 8 × 10⁻⁵ | mol |
|---|---|---|
| Water to make | 20.0 | ml |

Preparation of Silver Halide Emulsion (B-24)

Similarly to the foregoing silver halide emulsion (B-22), silver halide emulsion (B-24) comprising monodisperse cubic grains having an average grain size (equivalent cubic edge length) of 0.50 μm was prepared, except that the solution (C21) was replaced by the following solution (E22), then, the pH was adjusted to 9.5 and after 3 min., the pH was again adjusted 5.5 and the addition of the solutions (A21) and (B21) was conducted.

| Solution (E22) | | |
|---|---|---|
| Iodide ion releasing compound 1 | 8 × 10⁻⁵ | mol |
| Water to make | 20.0 | ml |
| Iodide ion releasing compound 1 | | |
| 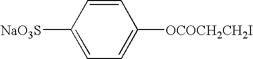 | | |

Preparation of Silver Halide Emulsion (B-25)

Similarly to the foregoing silver halide emulsion (B-24), silver halide emulsion (B-25) comprising monodisperse cubic grains having an average grain size (equivalent cubic edge length) of 0.50 μm was prepared, except that the solution (D22) was replaced by the following solution (D23), then, the pH was adjusted to 9.5 after addition of solution (E22) and after 3 min., the pH was again adjusted 5.5 and the addition of the solutions (A21) and (B21) was conducted.

Solution (D23)

| | | |
|---|---|---|
| Potassium bromide | 5.4 | g |
| Water to make | 23.0 | ml |

Preparation of Silver Halide Emulsion (B-26)

Similarly to the foregoing silver halide emulsion (B-25), silver halide emulsion (B-26) comprising monodisperse cubic grains having an average grain size (equivalent cubic edge length) of 0.50 μm was prepared, except that the solution (E22) was replaced by the following solution (E23), then, the pH was adjusted to 9.5 and after 3 min., the pH was again adjusted 5.5 and the addition of the solutions (A21) and (B21) was conducted.

Solution (E23)

| Iodide ion releasing compound 1 | 2 × 10⁻⁴ | mol |
|---|---|---|
| Water to make | 50.0 | ml |

Preparation of Silver Halide Emulsion (B-27)

Similarly to the foregoing silver halide emulsion (B-26), silver halide emulsion (B-27) comprising monodisperse cubic grains having an average grain size (equivalent cubic edge length) of 0.50 μm was prepared, except that the solution (C23) was replaced by the following solution (D24):

Solution (D24)

| | | |
|---|---|---|
| Potassium bromide | 5.44 | g |
| Water to make | 300.0 | ml |

Preparation of Silver Halide Emulsion (B-28)

Similarly to the foregoing silver halide emulsion (B-27), silver halide emulsion (B-28) comprising monodisperse cubic grains having an average grain size (equivalent cubic edge length) of 0.50 μm was prepared, except that the solution (A21) was replaced by the following solution (A24):

Solution (A24)

| | | |
|---|---|---|
| Sodium chloride | 72.3 | g |
| K₂[IrCl₆] | 9.0 × 10⁻⁹ | mol/mol AgX |
| K₂[IrBr₆] | 4.0 × 10⁻⁹ | mol/mol AgX |
| K₂[IrCl₅(H₂O)] | 9.0 × 10⁻⁸ | mol/mol AgX |
| K₂[IrCl₅(thiazole)] | 5.0 × 10⁻⁹ | mol/mol AgX |
| K₄[Fe(CN)₆] | 2.8 × 10⁻⁵ | mol/mol AgX |
| Water to make | 420 | ml |

Preparation of Silver Halide Emulsion (B-29)

Similarly to the foregoing silver halide emulsion (B-27), silver halide emulsion (B-29) comprising monodisperse cubic grains having an average grain size (equivalent cubic edge length) of 0.50 μm was prepared, except that the solution (A21) was replaced by the following solution (A25):

Solution (A25)

| | | |
|---|---|---|
| Sodium chloride | 72.3 | g |
| K₂[IrCl₆] | 7.0 × 10⁻⁹ | mol/mol AgX |
| K₂[IrBr₆] | 4.0 × 10⁻⁹ | mol/mol AgX |
| K₂[IrCl₅(H₂O)] | 1.3 × 10⁻⁷ | mol/mol AgX |
| K₂[IrBr₅(H₂O)] | 9.0 × 10⁻⁹ | mol/mol AgX |
| K₂[IrCl₅(thiazole)] | 3.0 × 10⁻⁹ | mol/mol AgX |
| K₄[Ru(CN)₆] | 2.6 × 10⁻⁵ | mol/mol AgX |
| Water to make | 420 | ml |

Preparation of Silver Halide Emulsions (G-21) to (G-29)

Silver halide emulsions (G-21) to (G-29) were prepared similarly to the foregoing silver halide emulsions (B-21) to (B-29), respectively, except that the addition time of solutions (A21), (A22), (A23), (A24), (A25), (B21), (B22) and (B23) was varied. The obtained silver halide emulsions (G-21) to (G-29) were each comprised of monodisperse cubic grains having an average grain size (equivalent cubic edge length) of 0.35 μm.

Preparation of Silver Halide Emulsions (R-21) to (R-29)

Silver halide emulsions (R-21) to (R-29) were prepared similarly to the foregoing silver halide emulsions (B-21) to (B-29), respectively, except that the addition time of solutions (A11), (A12), (A13), (A14), (A15), (B11), (B12) and (B3) was varied. The obtained silver halide emulsions (R-21) to (R-29) were each comprised of monodisperse cubic grains having an average grain size (equivalent cubic edge length) of 0.30 μm.

Characteristics of silver halide emulsions (B-21) to (B-29), (G-21) to (G-29) and (R-21) to (R-29) are shown in Table 11. It was proved that in each of the foregoing emulsions, the average aspect ratio of silver halide grains was less than 1.3 and more than 50% by number of the silver halide grains was accounted for by grains having a chloride content of not less than 90 mol %, an iodide content of from 0.02 to 2 mol % and a bromide content of from 0.1 to 9 mol %.

TABLE 11

| | Average | | Average | Average | Average | | | | | |
|---|---|---|---|---|---|---|---|---|---|---|
| | Grain | | Chloride | Bromide | Iodide | Average | Proportion- | Proportion- | | |
| | Size | CV-1*¹ | Content | Content | Content | Aspect | 1*² | 2*³ | | |
| Emulsion | (μm) | (%) | (mol %) | (mol %) | (mol %) | Ratio | (%) | (%) | CV-3*⁴ | Remark |
| B-21 | 0.50 | 0.07 | 99.46 | 0.5 | 0.04 | 1.13 | 36 | 25 | 36 | Comp. |
| B-22 | 0.50 | 0.07 | 98.76 | 1.2 | 0.04 | 1.13 | 38 | 24 | 35 | Comp. |
| B-23 | 0.50 | 0.07 | 98.76 | 1.2 | 0.04 | 1.13 | 55 | 45 | 33 | Inv. |
| B-24 | 0.50 | 0.07 | 98.76 | 1.2 | 0.04 | 1.13 | 66 | 52 | 34 | Inv. |
| B-25 | 0.50 | 0.07 | 97.46 | 2.5 | 0.04 | 1.13 | 74 | 67 | 32 | Inv. |
| B-26 | 0.50 | 0.07 | 97.4 | 2.5 | 0.1 | 1.13 | 89 | 80 | 30 | Inv. |
| B-27 | 0.50 | 0.07 | 97.4 | 2.5 | 0.1 | 1.13 | 93 | 86 | 16 | Inv. |
| B-28 | 0.50 | 0.07 | 97.4 | 2.5 | 0.1 | 1.13 | 93 | 86 | 16 | Inv. |
| B-29 | 0.50 | 0.07 | 97.4 | 2.5 | 0.1 | 1.13 | 93 | 86 | 16 | Inv. |
| G-21 | 0.35 | 0.07 | 99.46 | 0.5 | 0.04 | 1.13 | 35 | 25 | 35 | Comp. |
| G-22 | 0.35 | 0.07 | 98.76 | 1.2 | 0.04 | 1.13 | 36 | 24 | 38 | Comp. |
| G-23 | 0.35 | 0.07 | 98.76 | 1.2 | 0.04 | 1.13 | 53 | 44 | 35 | Inv. |
| G-24 | 0.35 | 0.07 | 98.76 | 1.2 | 0.04 | 1.13 | 64 | 53 | 33 | Inv. |
| G-25 | 0.35 | 0.07 | 97.46 | 2.5 | 0.04 | 1.13 | 72 | 65 | 32 | Inv. |
| G-26 | 0.35 | 0.07 | 97.4 | 2.5 | 0.1 | 1.13 | 86 | 77 | 32 | Inv. |
| G-27 | 0.35 | 0.07 | 97.4 | 2.5 | 0.1 | 1.13 | 91 | 82 | 17 | Inv. |
| G-28 | 0.35 | 0.07 | 97.4 | 2.5 | 0.1 | 1.13 | 91 | 82 | 17 | Inv. |
| G-29 | 0.35 | 0.07 | 97.4 | 2.5 | 0.1 | 1.13 | 91 | 82 | 17 | Inv. |
| R-21 | 0.30 | 0.08 | 99.46 | 0.5 | 0.04 | 1.13 | 33 | 25 | 37 | Comp. |
| R-22 | 0.30 | 0.08 | 98.76 | 1.2 | 0.04 | 1.13 | 35 | 27 | 39 | Comp. |
| R-23 | 0.30 | 0.08 | 98.76 | 1.2 | 0.04 | 1.13 | 52 | 44 | 36 | Inv. |
| R-24 | 0.30 | 0.08 | 98.76 | 1.2 | 0.04 | 1.13 | 63 | 51 | 36 | Inv. |
| R-25 | 0.30 | 0.08 | 97.46 | 2.5 | 0.04 | 1.13 | 73 | 66 | 32 | Inv. |
| R-26 | 0.30 | 0.08 | 97.4 | 2.5 | 0.1 | 1.13 | 86 | 76 | 33 | Inv. |
| R-27 | 0.30 | 0.08 | 97.4 | 2.5 | 0.1 | 1.13 | 90 | 80 | 17 | Inv. |
| R-28 | 0.30 | 0.08 | 97.4 | 2.5 | 0.1 | 1.13 | 90 | 80 | 17 | Inv. |
| R-29 | 0.30 | 0.08 | 97.4 | 2.5 | 0.1 | 1.13 | 90 | 80 | 17 | Inv. |

*¹coefficient of variation in grain size among grains
*²proportion (% by number) of silver halide grains having an iodide content of corner regions of 0.6A to 1.4A
*³proportion (% by number) of silver halide grains having an iodide content of corner regions of 0.7A to 1.3A
*⁴coefficient of variation in bromide content among grains

Preparation of Blue-Sensitive Emulsion

Similarly to silver halide emulsions (B-1a) to (B-9a) of Example 1, silver halide emulsions (B-21) to (B-29) were subjected to chemical and spectral sensitization to obtain blue-sensitive silver halide emulsions (B-21a) to (B-29a).

Similarly to silver halide emulsion (B-9b) of Example 1, silver halide emulsion (B-29) was subjected to chemical and spectral sensitization to obtain blue-sensitive silver halide emulsion (B-29b).

Preparation of Green-Sensitive Emulsion

Similarly to silver halide emulsions (G-1a) to (G-9a) of Example 1, silver halide emulsions (G-21) to (G-29) were subjected to chemical and spectral sensitization to obtain green-sensitive silver halide emulsions (G-21a) to (G-29a).

Similarly to silver halide emulsion (G-9b) of Example 1, silver halide emulsion (G-29) was subjected to chemical and spectral sensitization to obtain green-sensitive silver halide emulsion (G-29b).

Preparation of Red-Sensitive Emulsion

Similarly to silver halide emulsions (R-1a) to (R-9a) of Example 1, silver halide emulsions (R-21) to (R-29) were subjected to chemical and spectral sensitization to obtain red-sensitive silver halide emulsions (R-21a) to (R-29a).

Similarly to silver halide emulsion (R-9b) of Example 1, silver halide emulsion (R-29) was subjected to chemical and spectral sensitization to obtain blue-sensitive silver halide emulsion (R-29b).

Similarly to sample 101 of Example 1, samples 301 to 310 were prepared, provided that silver halide emulsion (R-1a) of the 1st layer, silver halide emulsion (G-1a) of the 3rd layer and silver halide emulsion (R-1a) of the 5th layer were respectively replaced, as shown in Table 12. The thus prepared samples were similarly evaluated. Results are shown in Table 13.

TABLE 12

| Sample | Silver Halide Emulsion | | | |
|---|---|---|---|---|
| No. | 1st Layer | 3rd Layer | 5th Layer | Remark |
| 301 | B-21a | G-21a | R-21a | Comp. |
| 302 | B-22a | G-22a | R-22a | Comp. |
| 303 | B-23a | G-23a | R-23a | Inv. |
| 304 | B-24a | G-24a | R-24a | Inv. |
| 305 | B-25a | G-25a | R-25a | Inv. |
| 306 | B-26a | G-26a | R-26a | Inv. |
| 307 | B-27a | G-27a | R-27a | Inv. |
| 308 | B-28a | G-28a | R-28a | Inv. |
| 309 | B-29a | G-29a | R-29a | Inv. |
| 310 | B-29b | G-29b | R-29b | Inv. |

TABLE 13

| | | Latent | | |
|---|---|---|---|---|
| Sample | | Image | Storage | |
| No. | S | Stability | Stability | Remark |
| 301 | 100 | 67 | 132 | Comp. |
| 302 | 102 | 68 | 130 | Comp. |
| 303 | 114 | 85 | 119 | Inv. |
| 304 | 118 | 89 | 117 | Inv. |
| 305 | 122 | 89 | 114 | Inv. |
| 306 | 125 | 91 | 113 | Inv. |
| 307 | 128 | 92 | 110 | Inv. |
| 308 | 132 | 95 | 106 | Inv. |
| 309 | 136 | 95 | 105 | Inv. |
| 310 | 139 | 96 | 105 | Inv. |

As is apparent from Table 13, it was proved that samples using the silver halide emulsion relating to this invention resulted in enhanced sensitivity, superior latent image stability and improved storage stability, as compared to comparative samples. It was further proved that when at least 50% by number of silver halide grains was accounted for by grains having an iodide content of corner regions of from 0.7 A to 1.3 A, the iodide content was 0.05 to 2.0 mol %, silver halide grains included an 8 group metal complex containing an aqua ligand and/or organic ligand, or the coefficient of variation in bromide content among grains was less than 30%, further superior results were achieved with respect to sensitivity, latent image stability and storage stability.

### Example 8

Samples 301 to 310 of Example 7 are evaluated similarly to Example 2. Results are shown in Table 14. Inventive samples achieved superior effects, as compared to comparative samples. Specifically, when the bromide content of silver halide grains and the iodide content of corner regions of silver halide grains were within the preferred range, further superior performance was achieved.

TABLE 14

| | Clearness | | Repro- | | |
|---|---|---|---|---|---|
| | of Fine | Skin Tone | duction | | |
| Sample | Line and | Repro- | of Leaves | Print | |
| No. | Letter | duction | Green | Reproducibility | Remark |
| 301 | D | D | D | D | Comp. |
| 302 | D | D | D | D | Comp. |
| 303 | B | B | B | B | Inv. |
| 304 | B | B | B | A | Inv. |
| 305 | A | B | A | A | Inv. |
| 306 | A | B | A | A | Inv. |
| 307 | A | B | A | A | Inv. |
| 308 | A | B | A | A | Inv. |
| 309 | A | B | A | A | Inv. |
| 310 | A | B | A | A | Inv. |

### Example 9

Samples 301 to 310 of Example 7 ere evaluated similarly to Example 3. Results are shown in Table 15. Inventive samples achieved superior effects, as compared to comparative samples. Specifically, when the bromide content of silver halide grains and the iodide content of corner regions of silver halide grains were within the preferred range, further superior performance was achieved.

TABLE 15

| | Clearness | | Repro- | | |
|---|---|---|---|---|---|
| | of Fine | Skin Tone | duction | | |
| Sample | Line and | Repro- | of Leaves | Print | |
| No. | Letter | duction | Green | Reproducibility | Remark |
| 301 | D | D | D | D | Comp. |
| 302 | D | D | D | D | Comp. |
| 303 | B | B | B | B | Inv. |
| 304 | B | B | A | A | Inv. |
| 305 | A | B | A | A | Inv. |
| 306 | A | B | A | A | Inv. |
| 307 | A | B | A | A | Inv. |
| 308 | A | B | A | A | Inv. |
| 309 | A | B | A | A | Inv. |
| 310 | A | B | A | A | Inv. |

What is claimed is:

1. A silver halide emulsion comprising silver halide grains, wherein the silver halide grains have an average aspect ratio of from 1.0 to 1.3 and at least 50% by number of the silver halide grains is accounted for by grains having a chloride content of not less than 90 mol %, an iodide content of from 0.02 to 2 mol %, a bromide content of from 0.1 to 9 mol % and a coefficient of variation in iodide content among grains of less than 40%.

2. The silver halide emulsion of claim 1, wherein the coefficient of variation in iodide content among grains is less than 30%.

3. The silver halide emulsion of claim 1, wherein the average bromide content is from 1.5 to 6.0 mol %.

4. The silver halide emulsion of claim 1, wherein the average iodide content is from 0.05 to 2.0 mol %.

5. The silver halide emulsion of claim 1, wherein silver halide grains exhibit a coefficient of variation in bromide content among grains is less than 30%.

6. The silver halide emulsion of claim 1, wherein the silver halide grains each contain a complex of a metal of group 8 of the periodical table of elements and the complex having at least one aqua ligand or at least one organic ligand.

7. The silver halide emulsion of claim 1, wherein the silver halide grains have been subjected to selenium sensitization.

8. A silver halide emulsion comprising silver halide grains, wherein the silver halide grains have an average aspect ratio of from 1.0 to 1.3 and at least 50% by number of the silver halide grains is accounted for by grains having a chloride content of not less than 90 mol %, an iodide content of from 0 to 2 mol %, a bromide content of from 0.1 to 10 mol %, and the silver halide grains have an average surface bromide content of from 0.3 to 10.0 mol %.

9. The silver halide emulsion of claim 8, wherein the average surface bromide content is from 2.5 to 10.0 mol %.

10. The silver halide emulsion of claim 8, wherein the average bromide content is from 1.5 to 6.0 mol %.

11. The silver halide emulsion of claim 8, wherein the average iodide content is from 0.05 to 2.0 mol %.

12. The silver halide emulsion of claim 8, wherein silver halide grains exhibit a coefficient of variation in bromide content among grains is less than 30%.

13. A silver halide emulsion comprising silver halide grains, wherein the silver halide grains have an average aspect ratio of from 1.0 to 1.3 and at least 50% by number of the silver halide grains is accounted for by grains having a chloride content of not less than 90 mol %, an iodide content of from 0.02 to 2 mol %, a bromide content of from 0.1 to 9 mol %, and the silver halide each have an iodide content of a corner region of the grain of from 0.6 A to 1.4 A mol %, wherein A is an average iodide content of corner regions of the grains.

14. The silver halide emulsion of claim 13, wherein the silver halide each have an iodide content of a corner region of the grain of from 0.7 A to 1.3 A mol %.

15. The silver halide emulsion of claim 13, wherein the average bromide content is from 1.5 to 6.0 mol %.

16. The silver halide emulsion of claim 13, wherein the average iodide content is from 0.05 to 2.0 mol %.

17. The silver halide emulsion of claim 13, wherein silver halide grains exhibit a coefficient of variation in bromide content among grains is less than 30%.

18. A silver halide photographic material comprising on a support at least one image forming layer, wherein the image forming layer comprises a silver halide emulsion as claimed in claim 1.

19. A silver halide photographic material comprising on a support at least one image forming layer, wherein the image forming layer comprises a silver halide emulsion as claimed in claim 8.

20. A silver halide photographic material comprising on a support at least one image forming layer, wherein the image forming layer comprises a silver halide emulsion as claimed in claim 13.
